(19) United States
(12) Patent Application Publication
(10) Pub. No.: US 2014/0344009 A1
(43) Pub. Date: Nov. 20, 2014

(54) STRATEGIC PLANNING PROCESS FOR END USER COMPUTING

(71) Applicant: VMware, Inc., Palo Alto, CA (US)

(72) Inventors: Matt Coppinger, Palo Alto, CA (US); Brian Gammage, Palo Alto, CA (US)

(73) Assignee: VMware, Inc., Palo Alto, CA (US)

(21) Appl. No.: 13/952,545

(22) Filed: Jul. 26, 2013

Related U.S. Application Data
(60) Provisional application No. 61/825,422, filed on May 20, 2013.

(51) Int. Cl. G06Q 10/06

(52) U.S. Cl. CPC G06Q 10/0637
USPC 705/7.28

(57) ABSTRACT

Systems and methods are described for obtaining a first governance score that is a measure of federation for a platform, a first risk score that is a measure of risk tolerance for the platform, a first audit score that is a measure of record keeping ability for the platform, a first productivity score that is a measure of workforce productivity for the platform, and a first elasticity score that is a measure of change tolerance for the platform. The method further obtains operational readiness scores that are measures of processes used to manage the platform within an organization, adjusts the first scores based on the operational readiness scores, calculates respective corresponding second scores pertaining to the organization, calculates a respective assessment for each of the adjusted first scores based on a comparison of the adjusted first score with the corresponding second score, and provides a summary of the assessments.

### CROSS-REFERENCE TO RELATED APPLICATIONS

This application claims priority under 35 U.S.C. §119(e)(1), to U.S. Provisional Application Ser. No. 61/825,422, filed on May 20, 2013, the entire contents of which are incorporated herein.

### BACKGROUND

This document relates to end user computing (EUC) and, in particular, to strategic planning for EUC.

As technology enhances lives, providing new and diverse options for increased efficiency and freedom both at home and in the workplace, organizations are faced with the challenge of equipping end users within their computing environment. This entails integrating a vast array of devices ranging from desktop computers to various mobile platforms (e.g., mobile phone, tablets, notebooks, laptop computers) with an organization's computing systems in an efficient and secure manner. In some cases, the mobile platforms and devices may not be separately integrated, secured, or managed by the end user's organization.

### SUMMARY

Organizations are faced with the challenge of how to provide and/or integrate the platforms and devices of various different users within an organization with the organization's computing resources. In order to do this, the organization also needs identify what requirements need to be met by the integration. In order to meet this challenge, organizations can build a technology roadmap that attempts to match up the range of available technology options with the functional and business needs of different groups of users within the organization, creating an EUC roadmap. The organization can use the EUC roadmap to identify how different groups of users should navigate different technology paths, attempting to match a technology path with the functional and business needs of each of the different groups of users.

In some implementations, a decision-framework application can provide a customer with a mechanism for developing EUC strategies that guides a customer through a question and answer type process in order to identify the customer's current and future business objectives. The application can model worker profiles, review the operational readiness of the organization, and evaluate a variety of technology choices against the worker profiles in light of the operational readiness and business objectives of the organization. The organization can use the results of this analysis to identify a high-level EUC strategy that provides a snapshot of the current EUC environment and a snapshot of a feasible potential future EUC environment. In some cases, the analysis can further provide return on investment (ROI) data.

In general, one aspect of the subject matter described in this document can be embodied in system and methods that include obtaining a first governance score where the first governance score is a measure of federation for a platform, wherein the platform comprises a device type attribute for a category of users, obtaining a first risk score where the first risk score is a measure of risk tolerance for the platform, obtaining a first audit score where the first audit score is a measure of record keeping ability for the platform, obtaining a first productivity score where the first productivity score is a measure of workforce productivity for the platform, and obtaining a first elasticity score where the first elasticity score is a measure of change tolerance for the platform. The systems and methods further include obtaining a plurality of operational readiness scores, where the operational readiness scores are measures of processes used to manage the platform within an organization, adjusting the first scores based on the operational readiness scores, calculating, for each of the first scores, a respective corresponding second score pertaining to the organization, calculating a respective assessment for each of the adjusted first scores based on a comparison of the adjusted first score with the corresponding second score, and providing a summary of the assessments.

These and other aspects can optionally include one or more of the following features. The platform further includes one or more of the following attributes: access and mobility information, personalization information, unified communications and collaboration information, application management and delivery information, data access information, desktop and workspace information, security and compliance information, and management information. Each first governance score is based on respective governance scores obtained for one or more of the platform attributes, each first risk score is based on respective risk scores obtained for one or more of the platform attributes, each first audit score is based on respective audit scores obtained for one or more of the platform attributes, each first productivity score is based on respective productivity scores obtained for one or more of the platform attributes, and each first elasticity score is based on respective elasticity scores obtained for one or more of the platform attributes. The user category is productivity task worker, communications task worker, office-based information worker, campus-based information worker, traveling worker or a very important person. Calculating the respective assessment for each of the adjusted first scores based on a comparison of the adjusted first score with the corresponding second score includes determining whether the adjusted first score is less than, greater than, or equal to the second score, and calculating the respective assessment based on the determination. The summary is a color-coded depiction of the assessments. The obtaining the plurality of operational readiness scores includes obtaining a first operational readiness score where the first operational readiness score is a measure of information technology strategy and management of the organization, obtaining a second operational readiness score where the second operational readiness score is a measure of processes that enable information technology to be provided as a service in the organization, obtaining a third operational readiness score where the third operational readiness score is a measure of business as usual operating processes for managing information technology in the organization, and obtaining a fourth operational readiness score where the fourth operational readiness score is a measure of design and creation of new or updated services in the organization. Adjusting a particular one of the first scores based on the operational readiness scores includes adjusting the particular first score based on one or more of the operational readiness scores. Adjusting a particular one of the first scores based on the operational readiness scores includes reducing the particular first score.

Particular embodiments of the subject matter described in this document can be implemented so as to realize one or more of the following advantages. An EUC planning tool can express and measure key business and technical characteristics of end-user computing deployments across an organization. Using the scores of the answers to a variety of questions, the EUC planning tool can create an EUC plan for a current state of the business that takes into account the current technical footprint of an organization along with the organization's capabilities to effectively utilize its technology. In addition, the EUC planning tool can create a desired future EUC plan for the organization by modeling a desired business state that utilizes a proposed technical footprint for the organization. An iterative process can be used where multiple future EUC plans can be generated based on different business state and technical footprint models for the organization. Organizations can then analyze multiple future EUC plans to determine the best plan for the long term goals of the organization before committing to the use of a specific technology.

The details of one or more embodiments of the subject matter described in this document are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example system that can execute implementations of the present disclosure.

FIG. 2A is a screen shot of an example user interface for entering customer details when creating an EUC plan.

FIG. 2B is a screen shot of an example user interface for entering current business status and future business objectives for an EUC plan.

FIGS. 3A-E show example questions and their associated scores for each parameter of the GRAPE model.

FIG. 4 shows an example table of cumulative scores for each parameter of the GRAPE model for a current business state and a desired future business state of an organization.

FIG. 5 is an example of a spider chart showing the cumulative GRAPE scores for a current business state and a desired future business state of an organization.

FIG. 6 is a screen shot of an example user interface for entering an EUC current state of end-user equipment for multiple categories of end-users included in an organization's workforce.

FIG. 7A is a screen shot of an example user interface for selecting platform, device and application specific information for each end-user category.

FIG. 7B is a table showing example platform, device and application specific information for each user category.

FIG. 8 shows an example table of average scores for each GRAPE parameter and an example user interface for entering data that characterizes a technical footprint for the organization.

FIG. 9A is a screen shot of an example user interface for entering operational readiness information for an organization.

FIG. 9B is a table showing example operational readiness scores for an organization.

FIG. 10A is a table is showing an example of operational readiness parameters and GRAPE parameters affected by the operational readiness parameters.

FIG. 10B is a table showing example resultant GRAPE parameter modifiers.

FIG. 10C is a table showing example GRAPE scores for each user category of an EUC current state of end-user equipment

FIG. 10D is a chart showing example GRAPE parameter outcomes for each user category and GRAPE model parameter for the current business state of an organization.

FIGS. 11A-E show an example report of an EUC plan.

FIG. 12 is a flow chart of an example method that can execute implementations of the present disclosure.

Like reference numbers and designations in the various drawings indicate like elements.

### DETAILED DESCRIPTION

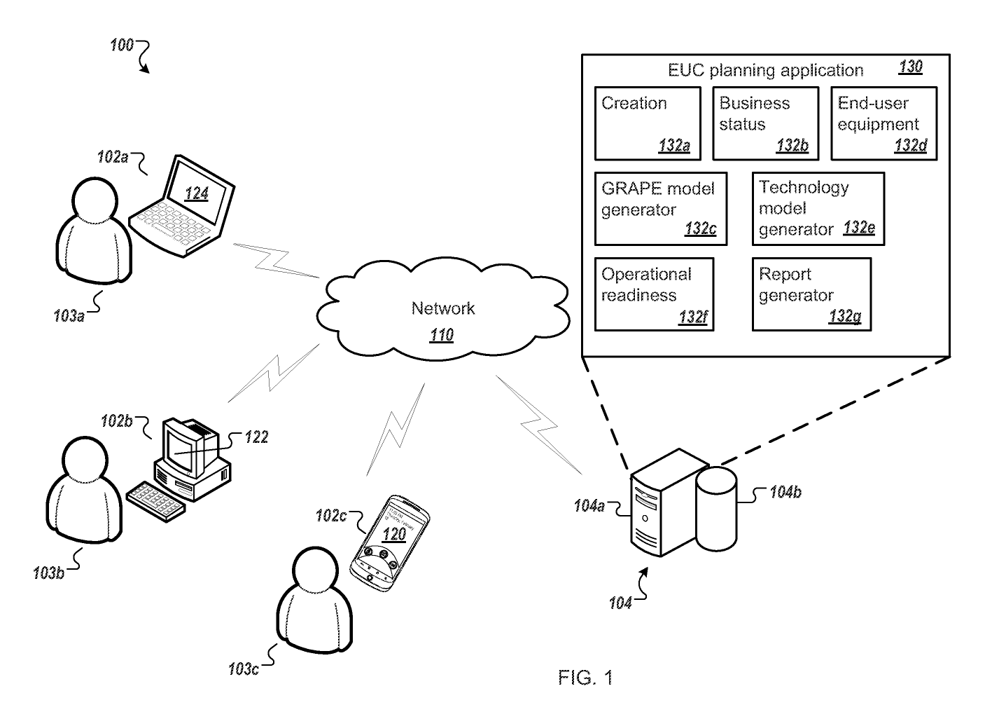

FIG. 1 is a block diagram illustrating an example system 100 that can execute implementations of the present disclosure. The system 100 includes one or more client devices (e.g., client devices 102a-c) that can communicate with one or more computing systems (e.g., computing system 104) using a network 110. A customer (e.g., customers 103a-c) can use the system 100 to run an EUC planning application 130 for creating and evaluating an EUC plan for an organization. For example, customers 103a-c can enter information into a user interface displayed on display devices 124, 122, 120, respectively. In some implementations, a web browser running on a client device can host the EUC planning application 130.

The EUC planning application 130 can include a plurality of software modules 132a-g that provide the functionality for creating and evaluating an EUC plan for an organization.

In the example of FIG. 1, the application can be implemented as one or more computer programs running on one or more computers (e.g., server 104a) in one or more locations that are coupled to each other and to the client devices 102a-c through a network (e.g., network 110). The application program can access data stored on a server database 104b. A database can refer to a collection of data: the data does not need to be structured in any particular way, or structured at all, and it can be stored on storage devices in one or more locations. For example, the database 104b can include multiple collections of data, each of which may be organized and accessed differently. An organization can store data in the database 104b that the application can then access when creating an EUC plan. In addition, the database 104b can store one or more EUC plans for an organization.

The network 110 can include, for example, a wireless cellular network, a wireless local area network (WLAN) or Wi-Fi network, a Third Generation (3G) or Fourth Generation (4G) mobile telecommunications network, a wired Ethernet network, a private network such as an intranet, a public network such as the Internet, or a combination thereof.

The client devices 102a-c are data processing apparatus such as, for example, mobile phones, tablet computers, notebook computers, laptop or desktop computers, PDAs, smart phones, or other stationary or portable devices. Among other components, the client devices 102a-c can include one or more processors, computer readable media that store software applications (e.g., a browser), an input module (e.g., a keyboard or mouse), a communication interface, and a display device (e.g., display devices 124, 122, and 120, respectively). For example, a client device can access application software on the computing system 104 that allows a user to create an EUC plan.

In operation, a client device (e.g., client devices 102a-c) can communicate with the computing system 104 by way of network 110. The client device can include one or more central processing units (CPUs) that may execute programs and applications included on the client device. The computing system 104 can include one or more central processing units (CPUs) that may execute programs and applications included on the computing system 104.

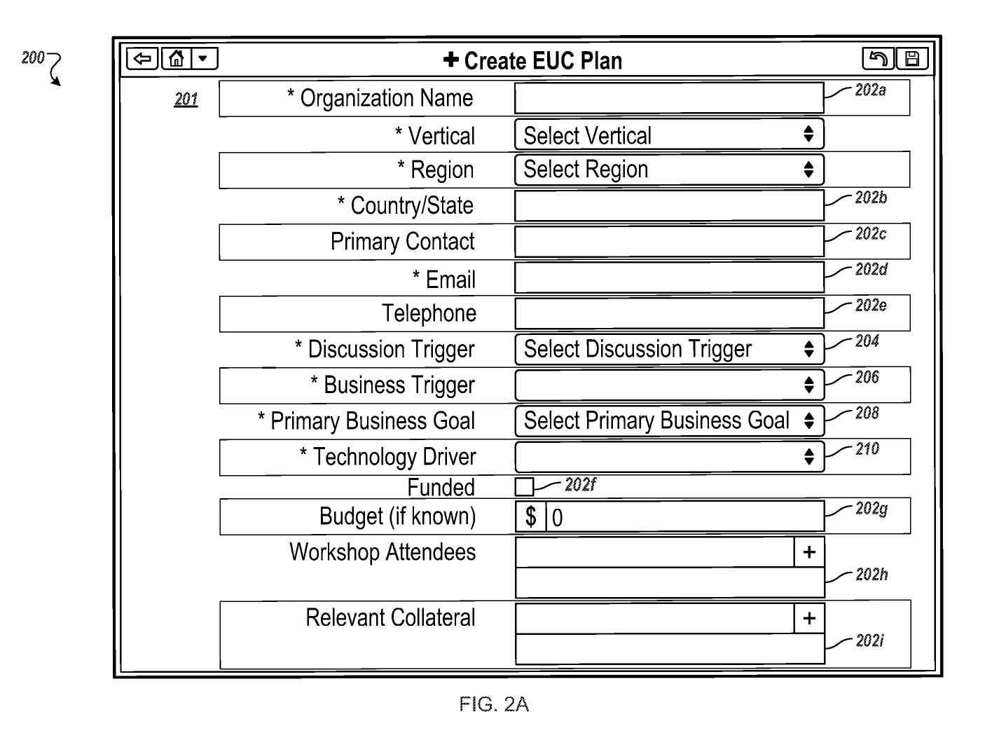

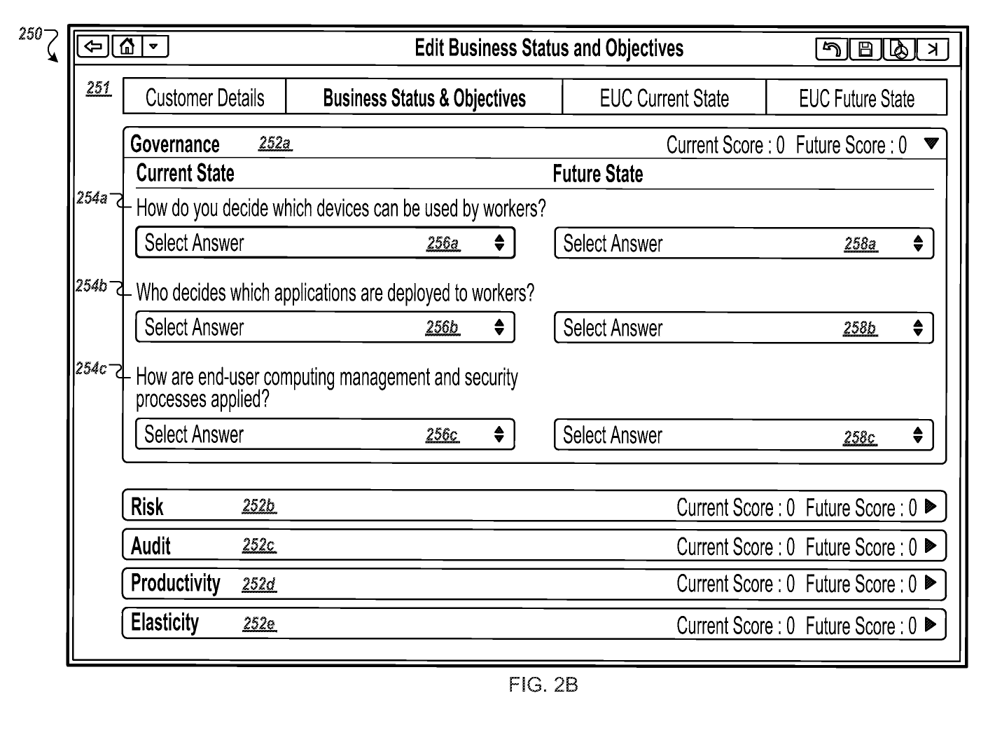

FIG. 2A is a screen shot 200 of an example user interface 201 for entering customer details when creating an EUC plan for an organization. Referring to FIG. 1, for example, the display device 122 can present the user interface 201 to the customer. A creation module 132a included in the EUC planning application 130 can generate the user interface 201. The customer, interacting with the input fields in the user interface 201, can enter and select information that the EUC planning application 130 can use to create an EUC plan. The customer can enter specific contact and other information for the organization in input fields 202a-i.

Input field 204 can provide the customer with one or more selection choices as a discussion trigger for the creation of the EUC plan. The discussion trigger can provide an indication of the motivation for the creation of the EUC plan. For example, the choices can include, but are not limited to, a direct customer request, a referral from another customer who created an EUC plan, a referral from another project with the customer, or public knowledge of the customer's requirements.

Input field 206 can provide the customer with one or more selection choices as a business trigger for the creation of the EUC plan. The business trigger can be a current or future change that may occur within the organization that may affect its business status and technology needs. For example, the choices can include, but are not limited to, a possible merger or acquisition, the addition of a new remote office, a temporary workforce expansion, a possible offshore initiative, a possible outsourcing initiative, or a change in regulatory requirements.

Input field 208 can provide the customer with one or more selection choices as a primary business goal or objective for the organization that the customer would like to achieve when implementing the EUC plan. For example, the choices can include, but are not limited to, increasing the workforce mobility, reducing operational costs, improving system availability, improving information security, increasing compliance and audit capabilities, enhancing service levels and service level agreements, or simplifying workforce changes and additions.

Input field 210 can provide the customer with one or more selection choices as a technology driver for the creation of the EUC plan. The technology driver can be a technology-based change that provides a reason for the creation of the EUC plan. For example, the choices can include, but are not limited to, an operating system migration, procurement of new hardware (e.g., replacement of obsolete hardware device and/or the procurement of new, additional hardware devices), the implementation of a “bring your own device” (BYOD) project, or an increase in support for additional multiple device types. The creation module 132a can store the data input and selected by the customer when interacting with the user interface 201 in the database 104b for subsequent use by other software modules included in the EUC planning application 130.

FIG. 2B is a screen shot 250 of an example user interface 251 for entering current business status and future business objectives for an EUC plan. The user interface 251 provides a question and answer format to a customer where the questions relate to parameters that characterize a business model for the organization. Referring to FIG. 1, for example, the display device 122 can present the user interface 251 to the customer. The business status module 132b included in the EUC planning application 130 can generate the user interface 251.

The model includes five parameters: a governance parameter 252a (the G parameter), a risk parameter 252b (the R parameter), an audit parameter 252c (the A parameter), a productivity parameter 252d (the P parameter), and an elasticity parameter 252e (the E parameter). The model can be referred to as the GRAPE model.

Governance can define the federation or the standardization of information systems and their inter-connection within the organization. For example, the G parameter can provide a measure or “score” for a current and future business status of governance within the organization providing a measure of the federation within the organization. Governance within an organization can be characterized by who within the organization makes decisions and how the technology within the organization is managed (e.g., from the middle or do business departments have autonomy). In the example of FIG. 2B, the customer is provided with questions 254a-c and user selectable answers 256a-c to each question that characterize a current business state and a user selectable answers 258a-c to each question that characterize a desired future business state for the organization. In some implementations, the user selectable answers for the current business state and the future business state for each question are the same, providing a common model for evaluating both the current business state and the desired future business state of an organization.

Risk can define an amount of uncertainty an organization is willing to tolerate when implementing an EUC plan. For example, the R parameter can provide a measure or “score” for a current and future business status of risk tolerance within the organization. Risk within an organization can be characterized by the organization's appetite for taking risk and the organizations ability to deal with and tolerate risk (e.g., managing the lifecycle of the organization's assets, does the life cycle of the assets drive the organization's buying cycle or vice versa, ability to tolerate outages).

Audit can define the record keeping ability of the organization as it relates to the organization's records. For example, the A parameter can provide a measure or “score” for a current and future business status related to the how the organization keeps and maintains its records. The A parameter can also provide an indication as to how regulation is implemented within the organization.

Productivity can define productivity within the organization's workforce. For example, the P parameter can provide a measure or “score” for a current and future business status related to how well technology supports workforce productivity within the organization. Productivity within an organization can be characterized by the perception by the workforce that they are being provided with the appropriate tools for performing their jobs (e.g., the workforce believes they have the right tools to do their job, they believe their productivity is higher than the productivity of their peers).

Elasticity can define a tolerance level for change within the organization. For example, the E parameter can provide a measure or “score” for a current and future business status related to change tolerance within the organization. Change tolerance within an organization can be characterized by how well the technology footprint of the organization tolerates additions and changes to the workforce, or mergers and acquisitions.

The GRAPE model can be used to evaluate the business drivers and objectives for both a current and projected future business state for the organization. When creating an EUC plan, a customer provides selectable answers to one or more questions associated with a specific GRAPE parameter. The customer provides answers to the questions for both the current business state of the organization and for a desired future business state of the organization.

Referring to FIG. 1, for example, the display device 122 can present the user interface 251 to the customer. The customer, interacting with the input fields in the user interface, can select an answer to the questions 254a-c presented in the user interface for a current business state and a desire future business state (answers 256a-c and answers 258a-c, respectively) for the governance parameter 252a. Though not shown in FIG. 2B, a similar user interface is presented to the customer for each of the GRAPE parameters, allowing the user to select answers to one or more questions used to characterize the GRAPE parameter for the current business state and for a desired future business state for the organization. The GRAPE parameters can be used to define where an organization is today (a current business status of an organization), where a customer would like their organization to be in the future (a desired future business status of the organization) for the purpose of supporting a strategic transformation of technology within the organization.

The business status module 132b can store the data selected by the customer (e.g., the answers to each of the questions) in the database 104b for subsequent use by other software modules included in the EUC planning application 130.

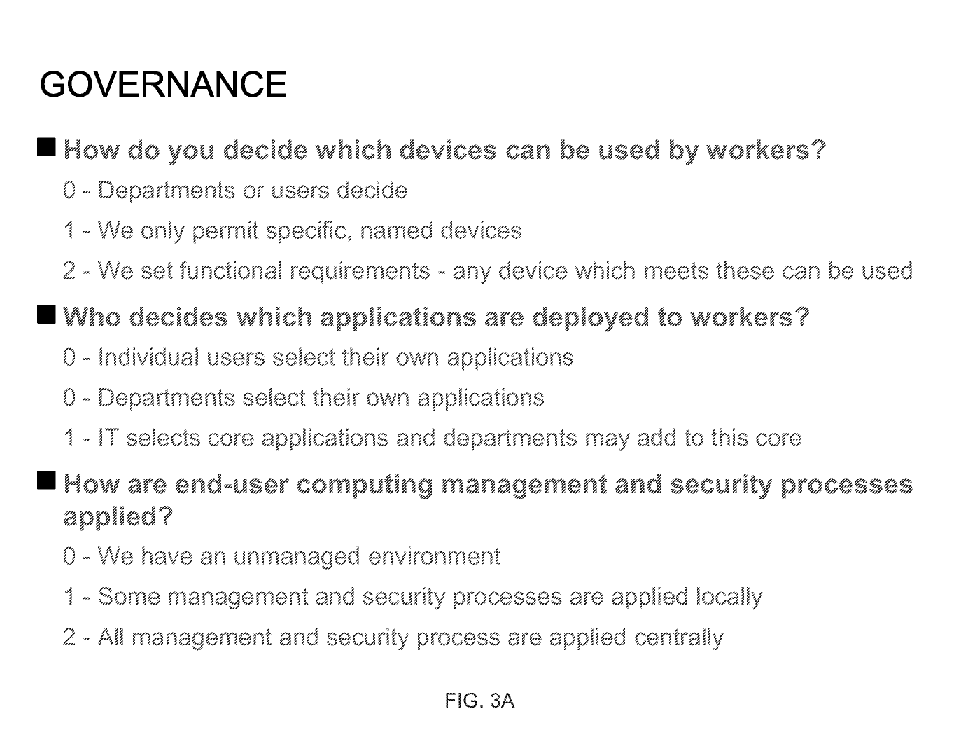

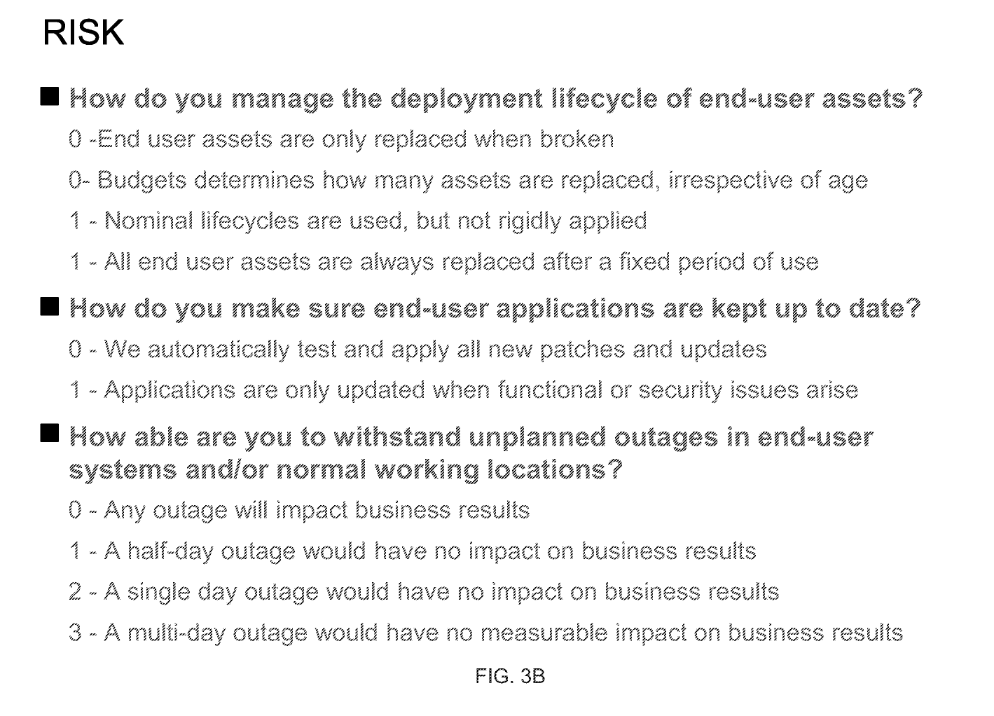

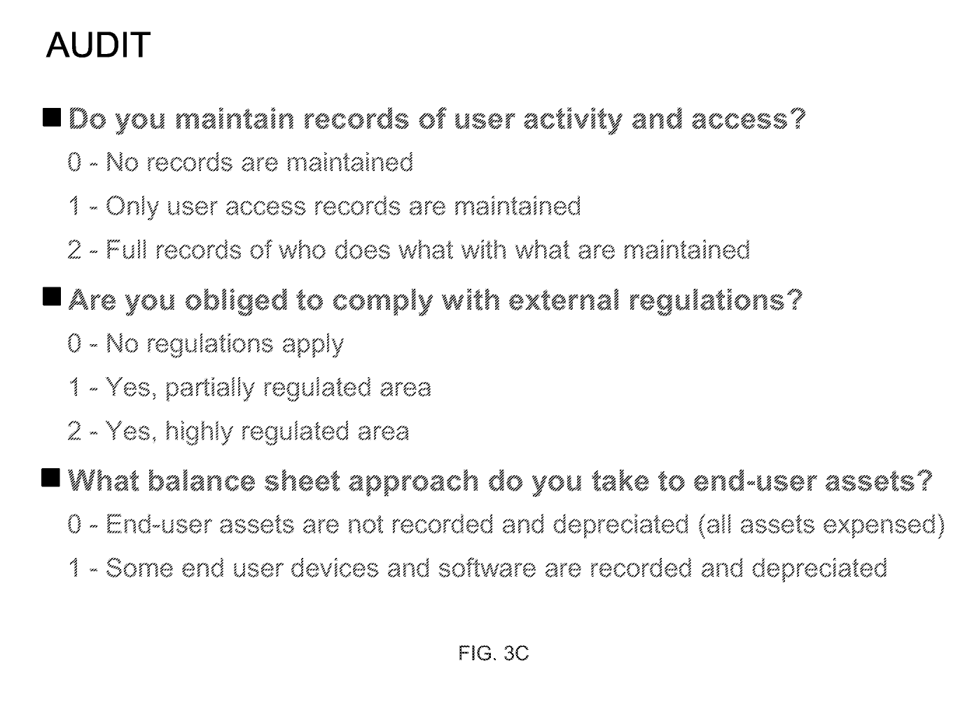

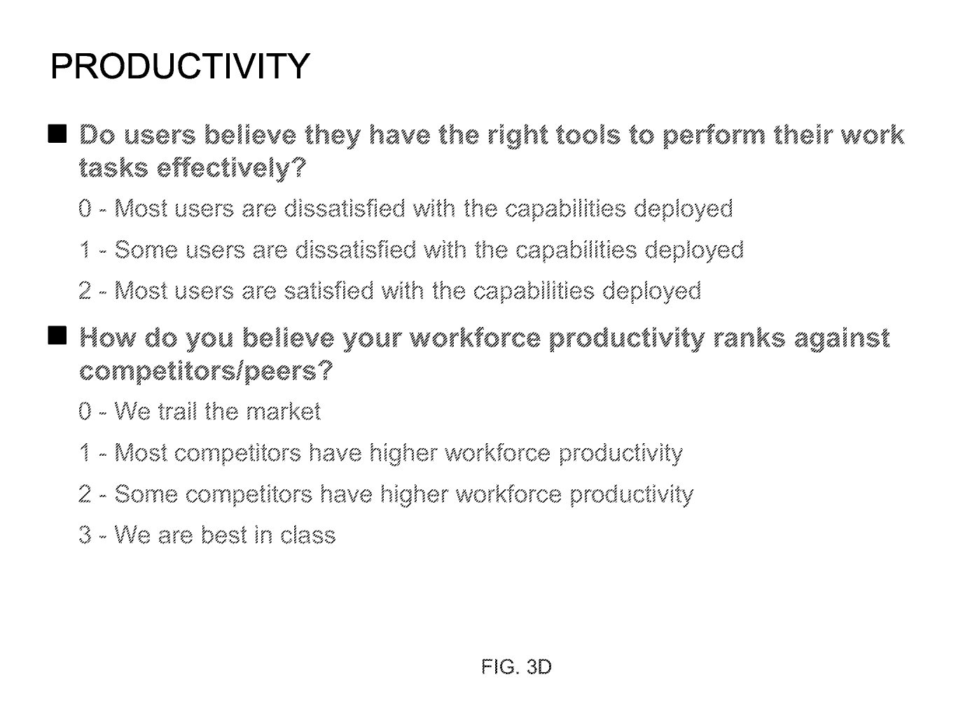

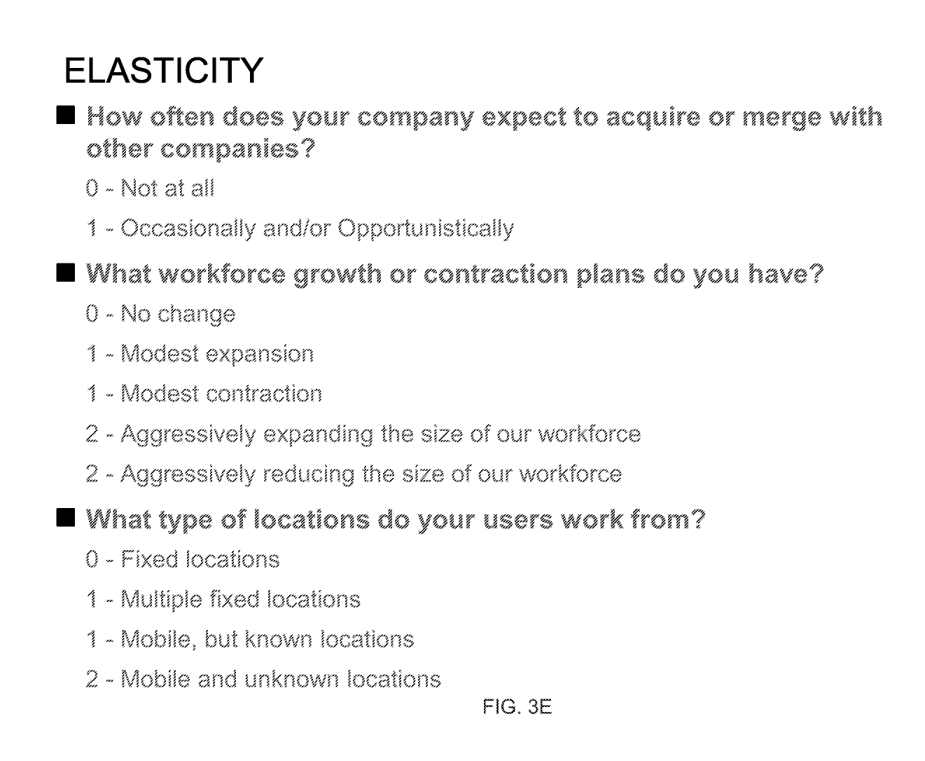

The answer to each question for the GRAPE parameters has an associated value or “score”. FIGS. 3A-E show example questions and their associated scores for each parameter of the GRAPE model. For example, the example questions and their associated scores for each parameter of the GRAPE model can be stored in the database 104b.

As described, the questions for each GRAPE model parameter are directed towards characterizing the respective parameter within the organization. The score for each answer are summed together to provide an overall cumulative score for the parameter. In some implementations, every question for each parameter for each business state must be answered in order to create the EUC plan.

The number of questions for each GRAPE parameter can be determined based on the desired accuracy of the decision framework provided by the GRAPE model. For example, the use of too many parameters in a decision framework can result in ambiguous answers. A limitation on the number of ways a particular cumulative score for each GRAPE parameter can be determined can be accomplished by limiting the number of questions or individual scores for each parameter. The type of question for each GRAPE parameter can be determined based on the criteria and issues involved in defining a technology transformation project as it relates to each individual GRAPE parameter.

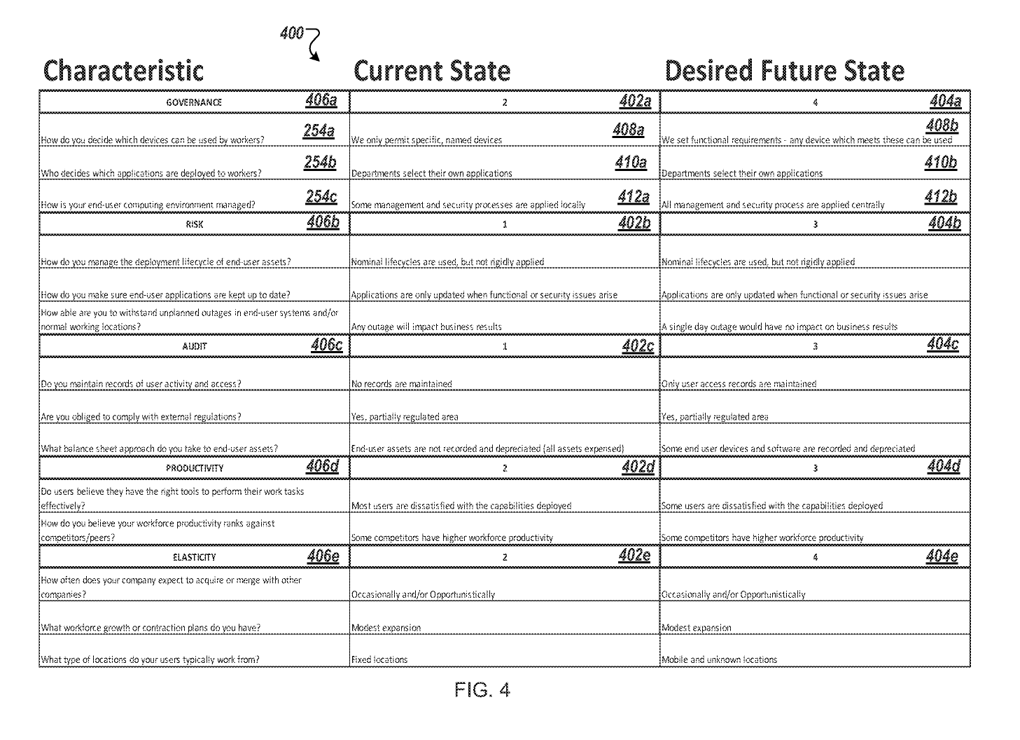

FIG. 4 shows an example table 400 of cumulative scores 402a-e, 404a-e for each parameter 406a-e of the GRAPE model for a current business state and a desired future business state of an organization, respectively. Each cumulative score 402a-e is the sum of the scores for each answer provided by the customer to the questions associated with the particular GRAPE parameter for a current business state and a desired future business state of the organization. A GRAPE model generator module 132c included in the EUC planning application 130 can access the database 104b to identify the scores assigned to each of the customer's selected answers to the questions for each GRAPE parameter. The GRAPE model generator module 132c can calculate the cumulative scores 402a-e for each parameter 406a-e of the GRAPE model.

For example, referring to FIGS. 2B, 3A, and 4, the customer selected the response 408a to question 254a when inputting information for a current business state for the governance parameter 252a and selected the response 408b when inputting information for a desired future business state for the governance parameter 252a. The customer also selected responses 410a-b and 412a-b in response to questions 254b and 254c for the current business state and the desired future business state, respectively. As shown in FIG. 3A, response 408a has an associated score of “1”, response 410a has an associated score of “0”, and response 412a has an associated score of “1”, resulting in the cumulative score 402a of “2” for the governance parameter in the current business state. Cumulative scores for the future business state of the governance parameter as well as the current and future business states of the remaining GRAPE parameters can be determined in a similar manner.

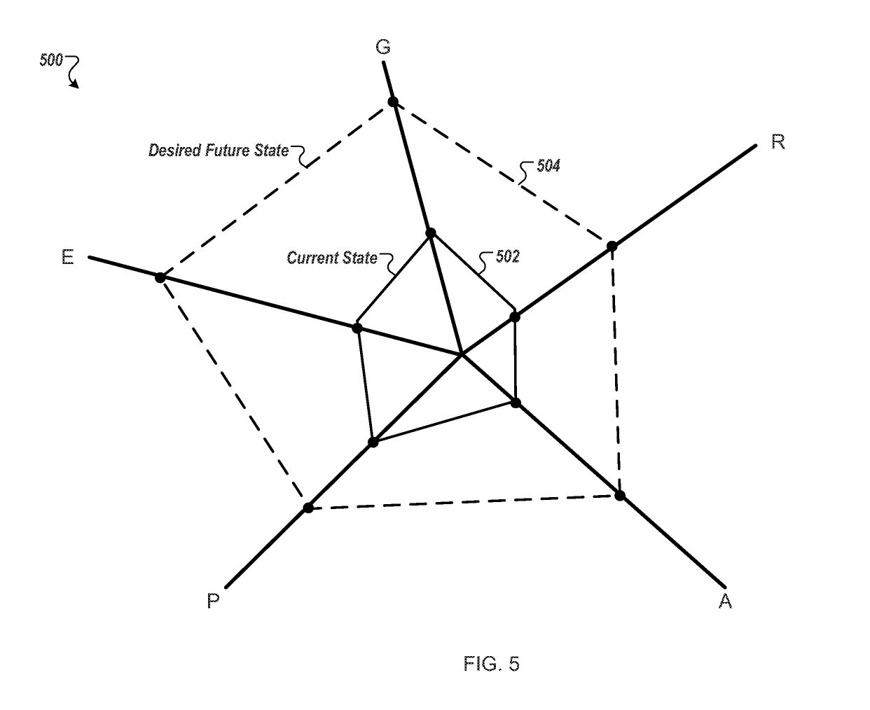

FIG. 5 is an example of a spider chart 500 showing the cumulative GRAPE scores for a current business state 502 and a desired future business state 504 for an organization. The spider chart 500 provides a visual representation of the business states 502 and 504. For example, referring to FIG. 1, the GRAPE model generator module 132c can generate the spider chart using the cumulative scores 402a-e, 404a-e for each parameter 406a-e of the GRAPE model to generate the plot of the current business state 502 and the desired future business state 504, respectively.

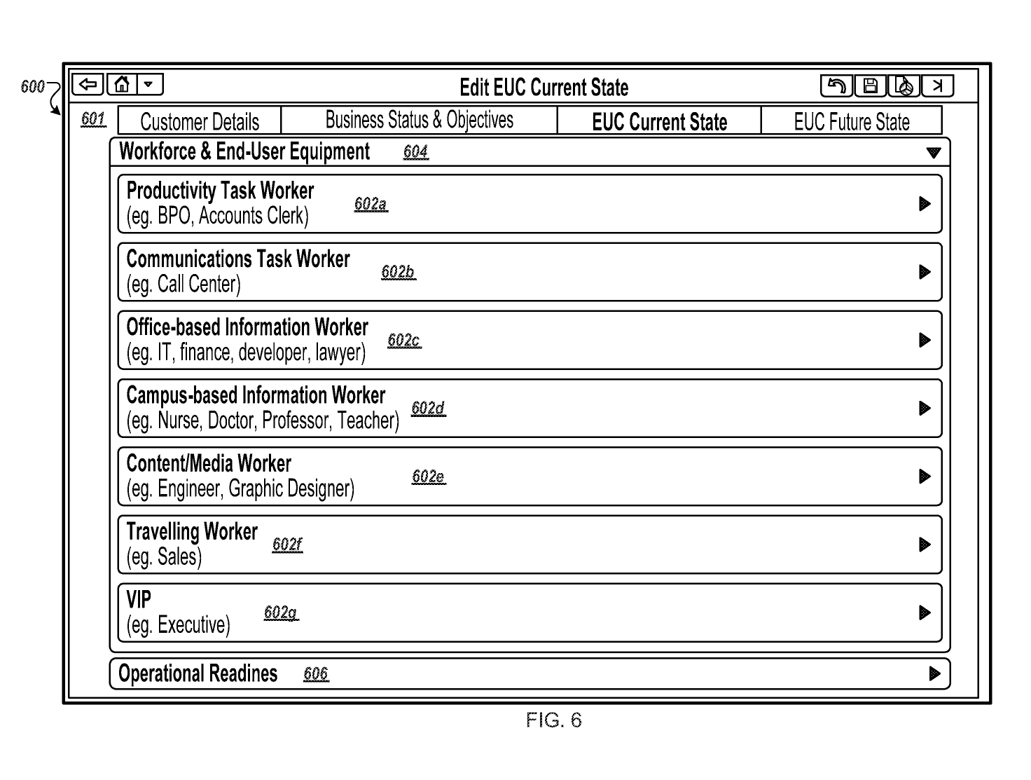

FIG. 6 is a screen shot of 600 an example user interface 601 for entering an EUC current state of end-user equipment 604 for multiple categories 602a-g of end-users identified as being included in an organization's workforce. Referring to FIG. 1, for example, the display device 122 can present the user interface 601 to the customer. An end-user equipment module 132d included in the EUC planning application 130 can generate the user interface 601. The customer interacting with the input fields in the user interface 601 can select a category 602a-g, for data input related to end-user equipment, for use by the end-user equipment module 132d.

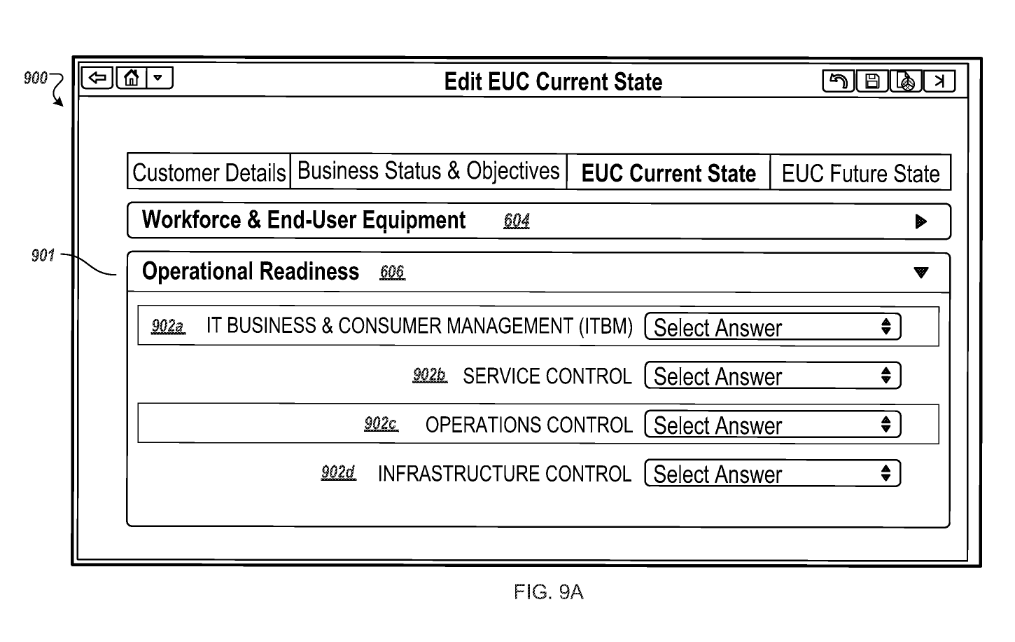

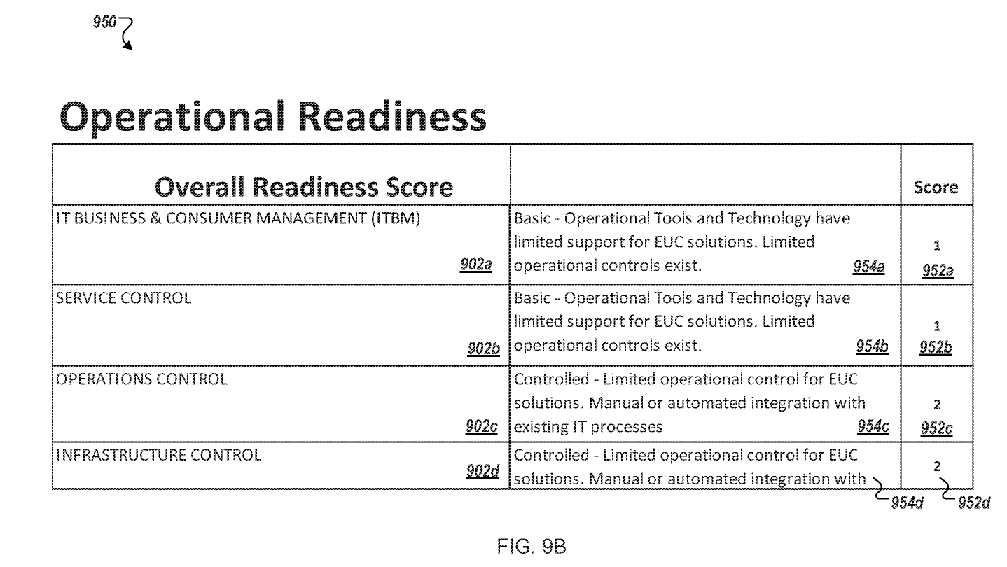

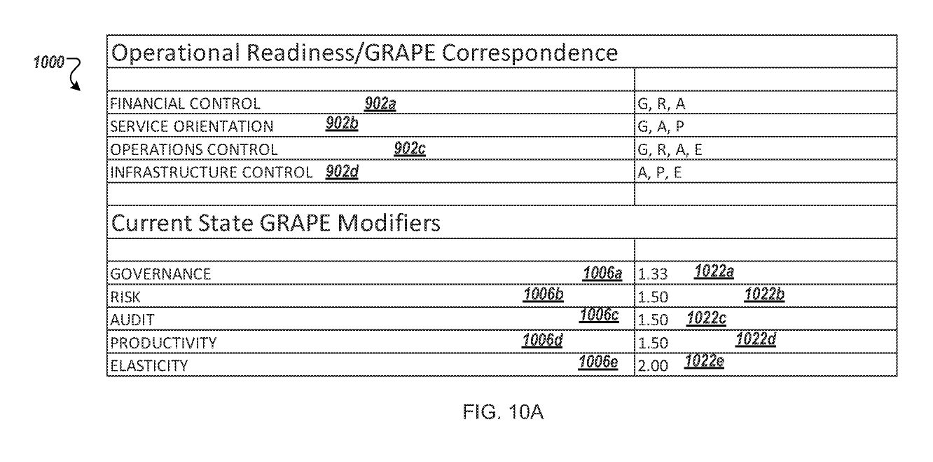

An organization can organize their workforce into groups of users or workers that fall into one of the multiple categories 602a-g. The example user interface 601 also includes an operational readiness selection 606 that, when selected, guides a user through entering information about an EUC current state of the operational readiness of the organization. This will be discussed in more detail with reference to FIGS. 9A-B.

A productivity task worker category 602a can include users who participate in a limited number of business processes in a clearly defined fashion. Examples of productivity task workers can include but are not limited to users who perform back office and administrative functions (e.g., accounts payable). Other examples of productivity task workers can include those users that perform outsourced functions. In most cases, the productivity task worker may need access to a small number of applications (e.g., less than ten) in a controlled and managed work environment. The productivity task worker is unlikely to work on the move, but may work remotely from more than one fixed location. The productivity task worker may have little autonomy in the way they can access processes, applications, and data from the organization.

A communications task worker category 602b can include users with a front line customer or colleague facing activity that the user can execute in a clearly defined fashion. Examples of communications task workers can include but are not limited to call center employees and retail assistants. The communications task worker may use one or two applications, but may require access to rapid communication and collaboration capabilities. In some cases, these capabilities may need to be multichannel. The communications task worker is unlikely to work on the move, but may work from more than one fixed location. The communications task worker may have little autonomy in the way they can access processes, applications, and data from the organization.

An office based information worker category 602c can include users with a skill set that can require assimilation and manipulation of information or input from multiple sources. Examples of office based information workers can include but are not limited to workers that are capable of performing higher-level back-office functions, such as finance, IT and mid-level management. The office based information worker may require the use of wide variety of applications. In addition, the office based information worker may require some level of control over how they access applications and data, but may not necessarily require full administrative control. The office based information worker is unlikely to work on the move, but may work from more than one fixed location. The office based information worker may require multi-channel communication and collaboration capabilities for working with peers.

A campus based information worker category 602d can include users with a skill set that requires assimilation and manipulation of information or input from multiple sources. The campus based information worker may also need to roam within a defined location or set of locations such as a campus or an office. Examples of campus based information workers include but are not limited to teachers, doctors, and many higher-level managers. The campus based information worker may require the use of wide variety of applications. The campus based information worker may require some level of control over how they access applications and data, but not necessarily require full administrative control. The campus based information worker may need to be mobile and must be able to access the organization's resources from anywhere within their remote working locations. The campus based information worker may require multi-channel communication and collaboration capabilities for working with peers, but may be willing to compromise system performance as a tradeoff for their extra allowed mobility.

A content/media worker category 602e can includes users with a high level of expertise in an area of creativity or science that may require detailed manipulation of content. The content/media workers may be considered the organization's power users. Examples of content/media workers can include but are not limited to engineers, graphic designers and some developers. The content/media worker may require a narrow, but specialized portfolio of accessible applications. The content/media worker is unlikely to work on the move and may work from a single, fixed location. The content/media worker may require some level of control over how they access applications and data, but not necessarily full administrative control and may be ring-fenced from the use of particular functions of the organization. The content/media worker may require high levels of computation capability and graphical display. The content/media worker may also require access to and the use of specialized peripheral devices.

A traveling worker category 602f can include users that spend at least fifty percent (50%) of their time in a non-office or campus location. The traveling worker may be oriented to a single function that may include interfacing with customers. Examples of traveling workers can include but are limited to sales representatives, service representatives, and drivers. The traveling worker may require access to a specific portfolio of applications and may create information content in a highly structured manner. The traveling worker may not require control over how they access the organization's applications or data, but may require access from almost any location within a particular geographic boundary.

A very important person (VIP) worker category 602g can include users with personal influence or power within an organization that makes them able to circumnavigate standard organizational policies. Examples of VIP workers can include but are not limited to business executives or persons within an organization in a position of trust. The VIP worker may require access to only a small number of applications, but they expect control over how they can access the applications and over how they can access the organization's data. The VIP worker may require unlimited mobile access.

Each user included in an end-user category requires a particular level of access to resources provided by an organization. Each user also requires access to these resources in a particular environment that can be based on the user's technology platform, device type and application type. The information that characterizes each user and the identity of each user included in a one of one or more groups of users can be stored in the database 104b.

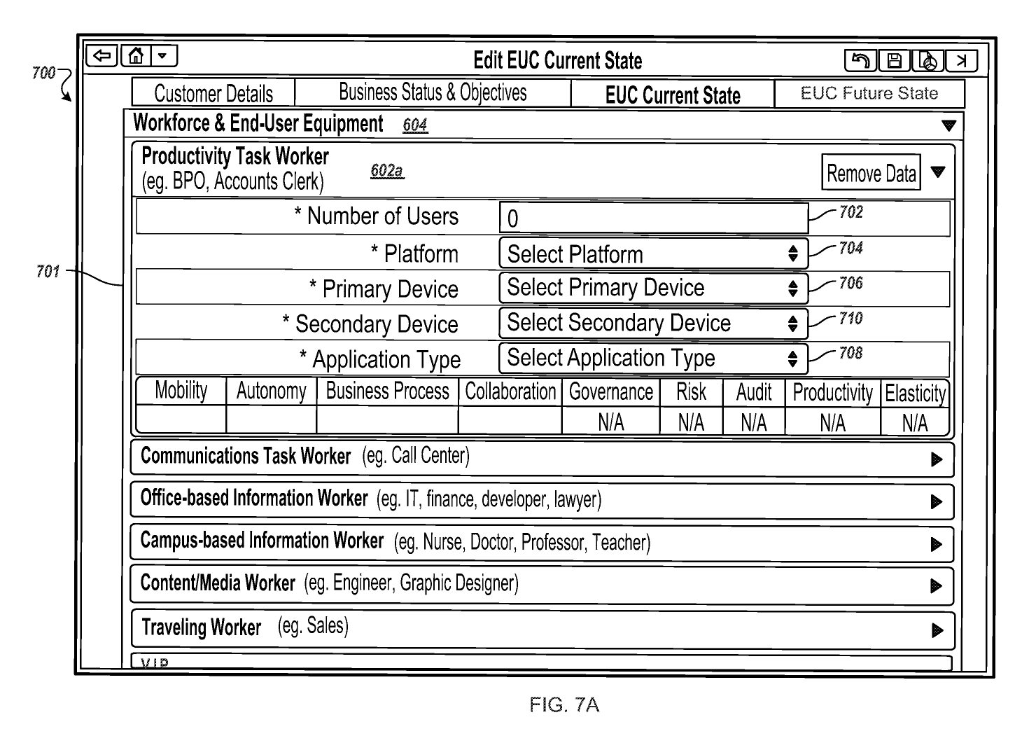

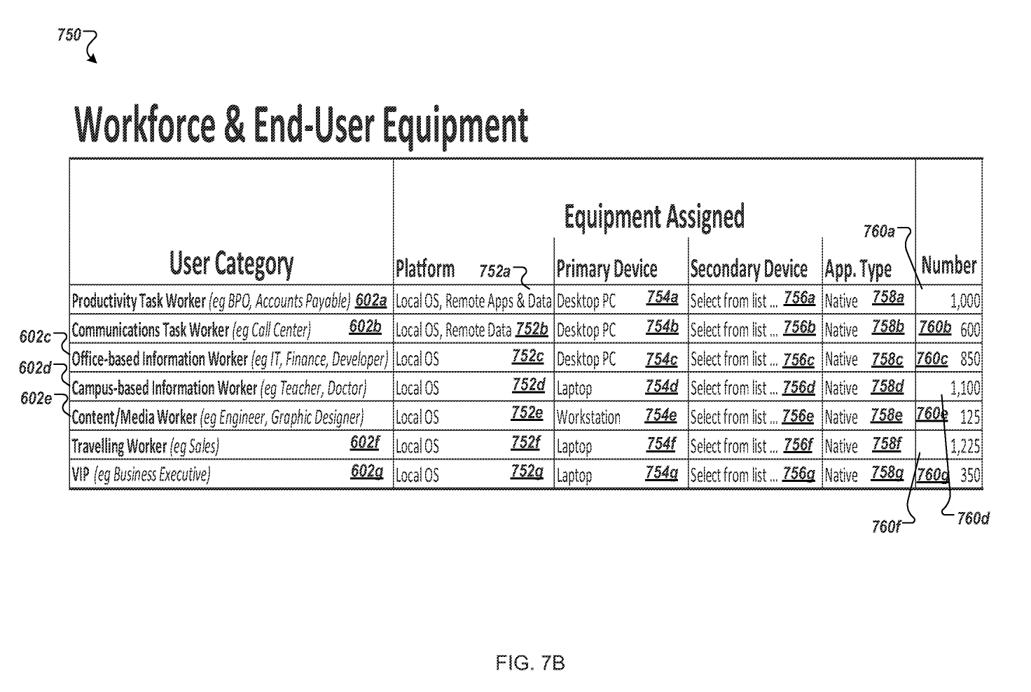

Referring to FIG. 1, for example, the display device 122 can present the user interface 601 to the customer. The customer, interacting with the input fields in the user interface 601, can select a user category, for example, the productivity task worker category 602a. Because of the selection, a user interface 701 can be displayed to the customer as shown in FIG. 7A.

FIG. 7A is a screen shot 700 of an example user interface 701 for selecting platform, device and application specific information for each end-user category. In addition, a customer can enter a number of users 702 that are included in the specific end-user category. The end-user equipment module 132d included in the EUC planning application 130 can generate the user interface 701. The display device 122 can present the user interface 701 to the customer. The customer, interacting with the input fields in the user interface 701, can enter and select data that the end-user equipment module 132d can store in the database 104b for subsequent use by other software modules (e.g., the GRAPE model generator module 132c) included in the EUC planning application 130.

Input field 704 can provide the customer with one or more selection choices for a platform for use by the users included in the productivity task worker category 602a. The selection choices for a platform can include but are not limited to the following fifteen template platforms as shown in Table 1 below. For example, Table 1 can be stored in the database 104b.

TABLE 1

| | PLATFORM TEMPLATE |
|---|---|
| 1 | Local Operating System (OS) |
| 2 | Local OS, Remote Data |
| 3 | Published Desktop |
| 4 | Local OS, Remote Applications (Apps) |
| 5 | Local OS, Remote Apps and Data |
| 6 | Local Virtual Desktop |
| 7 | Software as a Service (SaaS) Application Manager |
| 8 | Mobile Secure Desktop |
| 9 | Business Process Desktop |
| 10 | Branch Office Desktop |
| 11 | Hybrid Desktop |
| 12 | Enterprise Application Catalog |
| 13 | Mobile Secure Workspace |
| 14 | Enterprise Workspace |
| 15 | Cloud Workspace |

Input field 706 can provide the customer with one or more selection choices for a device type for use by the users included in the productivity task worker category 602a. The selection choices for a device type can include but are not limited to: a desktop computer, a repurposed desktop computer, a laptop computer, a computer workstation, a thin client computer, a zero client computer, a tablet computer, a smartphone, a BYOD, or any type of computing device.

Input field 708 can provide the customer with one or more selection choices for an application type for use by the users included in the productivity task worker category 602a. The selection choices for an application type can include but are not limited to: none (no selection of an application type), a native application type, a virtualized application type or a SaaS or web-based application type.

In some implementations, when selecting a platform for an EUC current state, the customer may be presented with a subset of choices reflective of the currently available platforms within the organization. In contrast, when selecting a platform for an EUC future state, the customer may be presented with currently available as well as additional platforms that may be incorporated into the organization in the future, providing the customer with the full set of fifteen template platform choices for the selection of a platform for an EUC future state. Additionally or alternatively, when selecting a device type for an EUC current state, the customer may be presented with a subset of device type choices reflective of the currently available device types within the organization. In contrast, when selecting a device type for an EUC future state, the customer may be presented with all ten of the device types for the selection of a device type for an EUC future state. Additionally or alternatively, when selecting an application type for an EUC current state, the customer may be presented with a subset of application type choices reflective of the currently available application types within the organization. In contrast, when selecting an application type for an EUC future state, the customer may be presented with all four of the application types for selection. Allowing the customer to select, when entering selections for an EUC desired future state, from among all potentially available choices results in the creation by the customer of an EUC future plan reflective of the potential impact on the organization of upgrades and additional procurement of hardware, devices and resources before the organization commits to the procurement.

The end-user equipment module 132d can determine the items to include as choices for the data entry selections included in the user interface 701 based on the EUC selected state for the data entry (e.g., EUC current state or EUC future state).

In addition, input field 710 can provide the customer with one or more selection choices for a secondary device type for use by the users included in the productivity task worker category 602a. The selection choices for a secondary device type can include but are not limited to: a desktop computer, a repurposed desktop computer, a laptop computer, a computer workstation, a thin client computer, a zero client computer, a tablet computer, a smartphone, or other types of computing devices.

Though not shown, a customer can select each of the categories 602b-g. The customer is then presented with the same user interface as shown for the productivity task worker category 602a shown in FIG. 7A. The customer can select a platform, a primary device type, a secondary device type, and an application type. The customer can also enter the number of users that are included in the selected end-user category.

FIG. 7B is a table 750 showing example platform 752a-g, device 754a-g, secondary device 756a-g, and application type 758a-g specific information for each user category 602a-g, respectively. In addition, a number of users 760a-g categorized into each of the user categories is shown in the table 750. The example platform 752a-g, device 754a-g, secondary device 756a-g, application type 758a-g, and number of users 760a-g information shown in table 750 is reflective of the selections and entries made by the customer interacting with the user interface shown in FIG. 7A. For example, the end-user equipment module 132d can store the data entered and selected by the customer in the database 104b.

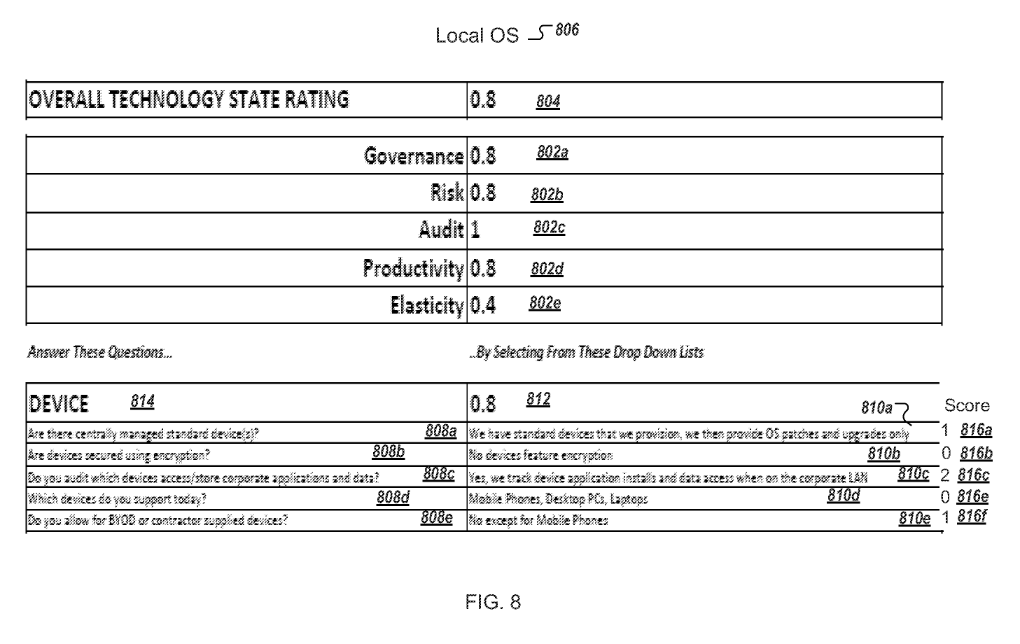

FIG. 8 shows an example portion of customer selected data that can be used to calculate a base GRAPE score 802a-e for each GRAPE model parameter, an average score 812 for a technology attribute 814, and an overall technology state rating 804 for a particular selected platform (e.g., a local OS 806). In some implementations, a customer is presented with a five questions for each of ten different technology attributes for each of the possible fifteen available platforms (listed in Table 1 above). The customer can select an answer to each question from a choice of six answers, where each answer is assigned a unique score of zero to five. In addition, each question is associated with a different one of the five GRAPE parameters. The score assigned to the selected answer to the question associated with a GRAPE parameter can be used to determine an average score for the particular GRAPE parameter. In addition, the scores assigned to each of the selected answers to the questions for a technology attribute (e.g., device technology attribute 814) can be used to determine an average score for the technology attribute (e.g., average score 812). For example, referring to FIG. 1, the technology model generator 132e can calculate the average score for each technology attribute.

The example shown in FIG. 8 shows five questions 808a-e, the customer selected answers 810a-e for each question 808a-e, and scores 816a-e assigned to each answer 810a-e. In this example, question 808a is associated with the governance or G parameter, question 808b is associated with the risk or R parameter, question 808c is associated with the audit or A parameter, question 808d is associated with the productivity or P parameter, and question 808e is associated with the elasticity or E parameter. A customer can select the answer 810a for the question 808a from a group of six answers, shown in Table 2 below, where each answer is assigned a unique score from zero to five. Other scores are possible. For example, the Table 2 can be stored in the database 104b.

TABLE 2

| ANSWERS | SCORES |
|---|---|
| We don't need to manage devices today as our solution | 5 |
| is device agnostic. | |
| We have standard devices that we provision, but these are | 4 |
| only access devices for remote hosted workspaces. | |
| We have a centrally managed solution for complete | 3 |
| management of all end user devices. | |
| We have standard devices that we provision that we | 2 |
| regularly update from an OS and application perspective. | |
| We have standard devices that we provision, we then | 1 |
| provide OS patches and upgrades only. | |
| We have standard devices that we provision for each | 0 |
| user, we do not manage them after that. | |

In the example, the customer selected the answer 810a, with an assigned score of “1”, to answer the question 808a. The customer continues to select answers 810b-e for questions 808b-e, respectively, from groups of six possible answers, where each answer is assigned a unique score of zero to five. The average score 812 for the device technology attribute 814 is the average value of the sum of the scores 816a-f.

The ten different technology attributes include but are not limited to: device, access and mobility, personalization, unified communications and collaboration, application management and delivery, data access, desktop and workspace, platform, security and compliance, and management.

Referring to FIG. 1, for example, the display device 122 can present a user interface to the customer that includes a listing of five questions for each of the technology attributes, and user selectable drop down lists that allow a customer to select an answer from a group of six possible answers for each question for each technology attribute. A technology model generator 132e can generate the user interface. The customer, interacting with the input fields in the user interface, can enter and select data that the technology model generator can store in the database 104b for its subsequent use or for use by other software modules (e.g., the GRAPE model generator module 132c) included in the EUC planning application 130.

Once the customer has selected answers to all of the questions for all of the technology attributes for a particular platform, an average score for each technology area for the particular platform is calculated by summing the scores of the answers to each of the five questions for the technology attribute and calculating the average of the summed scores. An average score for each GRAPE parameter is calculated by summing the scores of the answers for a particular GRAPE parameter for each of the ten technology attributes for the particular platform and calculating the average of the summed scores. These average scores comprise the base GRAPE score 802a-e for the particular platform (e.g., local OS 806). For example, referring to FIG. 1, the GRAPE model generator module 132c can calculate the average score for each GRAPE parameter. The overall technology state rating 804 for the particular platform (e.g., local OS 806) is the average of the GRAPE scores 802a-e. For example, referring to FIG. 1, the GRAPE model generator module 132c can calculate the overall technology rating. Though not shown, this process can be repeated for each of the fifteen template platforms, as listed in Table 1 above.

FIG. 9A is a screen shot 900 of an example user interface 901 for entering operational readiness information for an organization. Referring to FIG. 1, for example, the display device 122 can present the user interface 901 to the customer. An operational readiness module 132f included in the EUC planning application 130 can generate the user interface 901. The customer, interacting with the input fields in the user interface 901, can enter and select information that the EUC planning application 130 can use to create an EUC plan.

The operational readiness information can be used to determine how an organization is currently managing their existing technology. A process maturity model can use the operational readiness information to determine if the organization's operating processes are mature enough to obtain the maximum benefits from the organization's existing technologies. In some cases, an organization may have the technology to deliver a desired result but may not have yet developed the processes needed to utilize the technology in order to achieve the desired result. This lack of readiness can act as a limit or ceiling on an organization's ability to realize the full value of its technology.

A customer can select an answer 904a-d for an operational readiness parameter 902a-d, respectively, from a group of six answers, shown below in Table 3, where each answer is assigned a unique score of zero to five. In some implementations, the same group of six answers is associated with each of the operational readiness parameters 902a-d. For example, the Table 3 can be stored in the database 104b.

TABLE 3

| Answers | Scores |
|---|---|
| Predictive - Self healing operations with ability to | 5 |
| automatically react to errors and prevent outages. | |
| Business Automation - Business critical services | 4 |
| offered and controlled within the EUC solution layer. | |
| Includes process management and control over | |
| orchestration and automation across multiple systems | |
| Service Orientation - Services defined through a | 3 |
| service catalog for direct consumption by business | |
| users. Complete operational control and quality of | |
| service assurance. | |
| Controlled - Limited operational control for EUC | 2 |
| solutions. Manual or automated integration with | |
| existing IT processes | |
| Basic - Operational Tools and Technology have | 1 |
| limited support for EUC solutions. Limited | |
| operational controls exist. | |
| No process exists | 0 |

An IT business and customer management (ITBM) parameter (operational readiness parameter 902a) is associated with processes required to define IT strategy, IT financial management including accounting and billing of end users or consumers, risk management and vendor management. IT business and customer management focuses on defining an “interface” to end users by providing a consumer based service catalogue, a consumer reporting processes and by managing demand (e.g., orders, pipeline etc.).

A service control parameter (operational readiness parameter 902b) is associated with processes that enable IT to be provided as a service. Service control can include development of a portfolio of services consumed by end-users and possibly by other business units, IT, and suppliers. Service control can provide these services using a service catalogue that may be separate from consumer service catalogue, by managing these services using service level agreements (SLAs), and a service desk. Service control can provide metering and chargeback for these services.

An operation control parameter (operational readiness parameter 902c) is associated with business as usual operational processes for managing IT services. These processes can include but are not limited to the provisioning, deployment and integration of infrastructure, ensuring infrastructure is available and is compliant with specified configurations. Operation control also covers the monitoring and responding to events, problems and incidents in the environment including the pro-active measurement and trending for capacity, and availability and performance management. Operation control can provide for access controls and security within the environment.

An infrastructure management parameter (operational readiness parameter 902d) is associated with the design and creation of new or updated services. Infrastructure management can include the design and architecture of new solutions as well as the provisioning and deployment of any new required infrastructure.

Infrastructure management differs from operations control as infrastructure management focuses on new services and architectures that may require new deployment/provisioning processes or solutions.

FIG. 9B is a table 950 showing example operational readiness scores 952a-d for an organization. The scores are assigned to answers 954a-d selected by a customer for each of the operational parameters 902a-d. The customer selected the answers 954a-d to each operational parameter 902a-d from a group of answers as shown in Table 3 above.

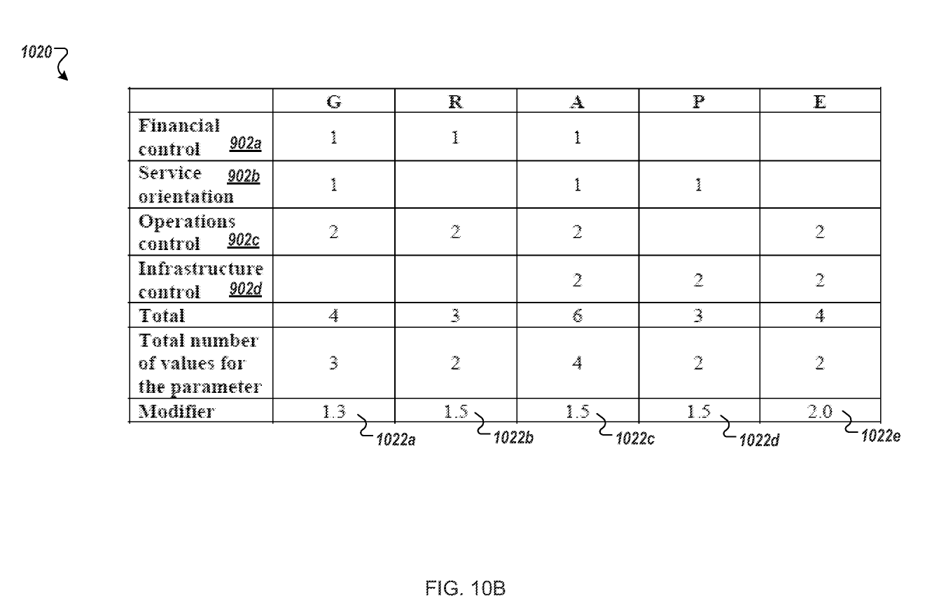

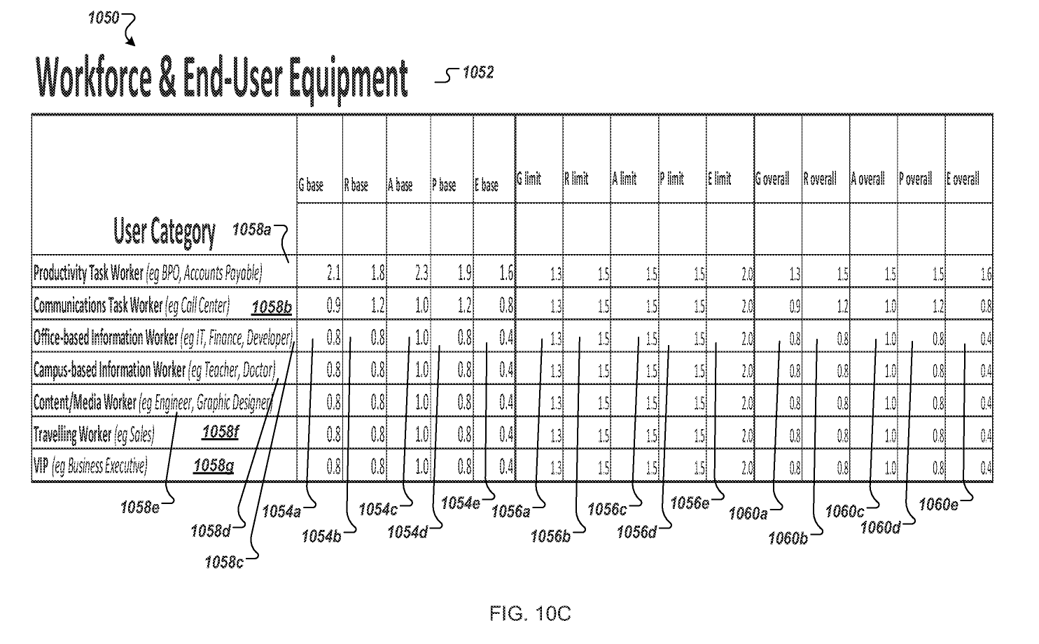

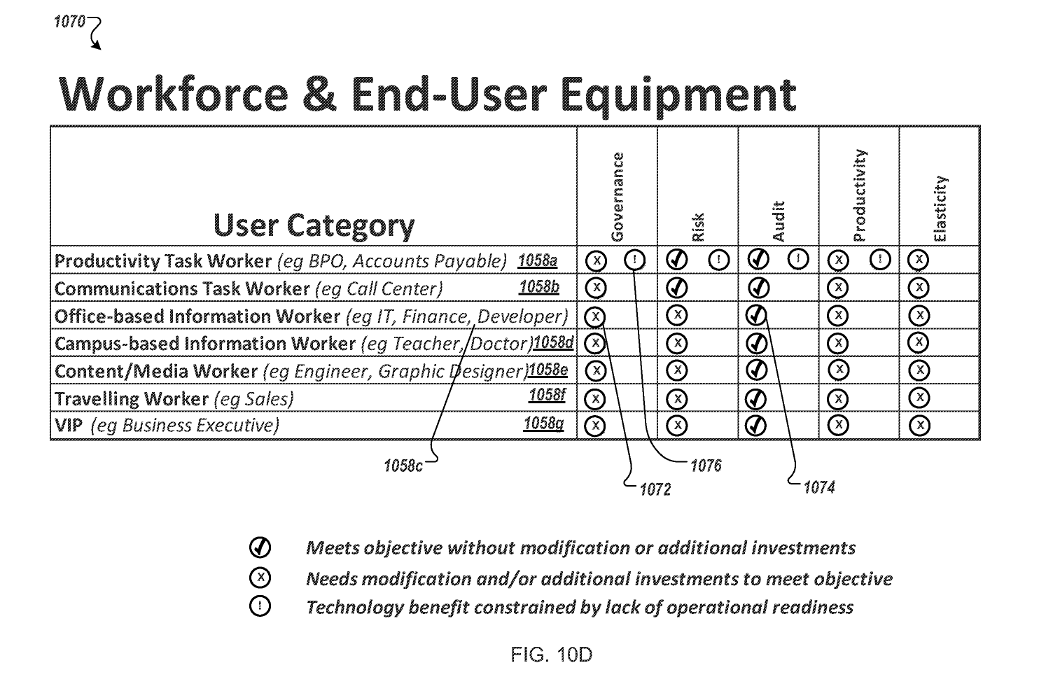

FIG. 10A is a table 1000 showing an example of operational readiness parameters 902a-d and GRAPE parameters affected by the operational readiness parameters 902a-d. Referring to FIGS. 4 and 9B, the scores 952a-d for each of the operational readiness parameters 902a-d can be used to modify or limit the respective current state GRAPE scores 402a-e. Referring to table 1000 and table 950, the score 952a for the operational readiness parameter 902a can be used as a modifier to the cumulative scores for the governance, risk and audit parameters of the current state GRAPE parameters (scores 402a-c). The score 952b for the operational readiness parameter 902b can be used as a modifier to the cumulative scores for the governance, audit, and productivity parameters of the current state GRAPE parameters (scores 402a, and 402c-d). The score 952c for the operational readiness parameter 902c can be used as a modifier to the cumulative scores for the governance, risk, audit, and elasticity parameters of the current state GRAPE parameters (scores 402a-c, and 402e). The score 952d for the operational readiness parameter 902d can be used as a modifier to the cumulative scores for the audit, productivity, and elasticity parameters of the current state GRAPE parameters (scores 402c-e).

FIG. 10B is a table 1020 showing example resultant GRAPE parameter modifiers 1022a-e. Referring to table 1000 in FIG. 10A and table 950 in FIG. 9B, the table 1020 shows each GRAPE parameter and the score for each operational readiness parameter that modifies a current GRAPE model parameter. For example, as described above and now shown in FIG. 10B, the score 952a (“1”) for the operational readiness parameter 902a can be used as a modifier to the cumulative scores for the governance, risk and audit parameters of the current state GRAPE parameters. The score 952b (“1”) for the operational readiness parameter 902b can be used as a modifier to the cumulative scores for the governance, audit, and productivity parameters of the current state GRAPE parameters. The score 952c (“2”) for the operational readiness parameter 902c can be used as a modifier to the cumulative scores for the governance, risk, audit, and elasticity parameters of the current state GRAPE parameters. The score 952d (“2”) for the operational readiness parameter 902d can be used as a modifier to the cumulative scores for the audit, productivity, and elasticity parameters of the current state GRAPE parameters. The modifiers 1022a-e for each of the GRAPE parameters are determined by summing the scores for each operational readiness parameter 902a-d for the respective GRAPE parameter and then dividing the sum of the scores by the total number of scores. For example, the modifier 1022a (“1.3”) is the sum of the scores for the “g” parameter for each operational readiness parameter 902a-d (“4”) divided by the total number of scores (“3”). The modifiers 102b-e are calculated in a similar manner.

Referring to FIG. 1, for example, the operational readiness module 132f can calculate the modifiers 1022a-e as described above.

Referring to FIG. 10A, table 1000 further includes the current state GRAPE modifier parameters 1022a-e for each GRAPE model parameter 1006a-e, respectively.

FIG. 10C is a table 1050 showing example GRAPE scores for each user category of an EUC current state of end-user equipment 1052. Referring to FIG. 8, GRAPE base parameters 1054a-e each correspond to the GRAPE parameters 802a-e, respectively. Referring to FIG. 10A, GRAPE modifier parameters 1056a-e each correspond to the GRAPE modifier parameters 1022a-e, respectively. GRAPE model overall parameters 1060a-e are determined by comparing, for each user category, the GRAPE base parameter value to the GRAPE modifier parameter value and selecting the lesser of the two values as the value for the overall GRAPE model parameter.

FIG. 10D is a chart 1070 showing example GRAPE parameter outcomes for each user category 1058a-g and GRAPE parameters for the current business state of an organization.

Referring to FIG. 10C, if the overall GRAPE parameter score is the GRAPE modifier parameter (the value of the GRAPE modifier parameter is less than the value of the GRAPE base parameter), this indicates the particular GRAPE parameter for the user category “needs modification and/or additional investments to meet objective”. An indicator 1072 (e.g., an “X”) is used to symbolize this condition.

Referring to FIG. 10C, if the overall GRAPE parameter score is the GRAPE base parameter (the value of the GRAPE modifier parameter is greater than or equal to the value of the GRAPE base parameter), this indicates the particular GRAPE parameter for the user category “Meets objective without modification or additional investments.” An indicator 1074 (e.g., a check mark (√)) is used to symbolize this condition.

In addition, an indicator 1076 (e.g., “!”) is used to indicate that the “Technology benefit was constrained by a lack of operational readiness” in cases where the overall GRAPE score was the GRAPE parameter modifier score because the value of the GRAPE parameter modifier score was less than the base GRAPE parameter score.

Referring to FIGS. 10A-D, in cases where, for a particular GRAPE model parameter, the value of the GRAPE modifier parameter is less than the value of the GRAPE base parameter, the GRAPE modifier parameter becomes a “ceiling” value for the determination of the overall GRAPE parameter score for the particular parameter. This indicates the organization's processes are not mature enough to obtain the maximum benefit of the technology the customer would like to deploy. In some implementations, referring to FIG. 10A, if the value of the Grape modifier parameter is less than three, then the Grape modifier parameter can be the “ceiling” value for the GRAPE parameter. If the value of the Grape modifier parameter is greater than or equal to three, no ceiling is applied to determine the value of the GRAPE overall parameter.

Referring to FIG. 1, for example, the display device 122 can present the chart 1070 to the customer. The end-user equipment module 132d can perform the determinations, comparisons, and calculations described in order to generate the chart 1070. The end-user equipment module 132d can generate the chart 1070 for display to the user, including the indicators 1072, 1074, 1076 that provide visual indications of the value of the overall GRAPE score for each user category 1058a-g. As such, the customer is presented with a visual representation of the resultant EUC plan.

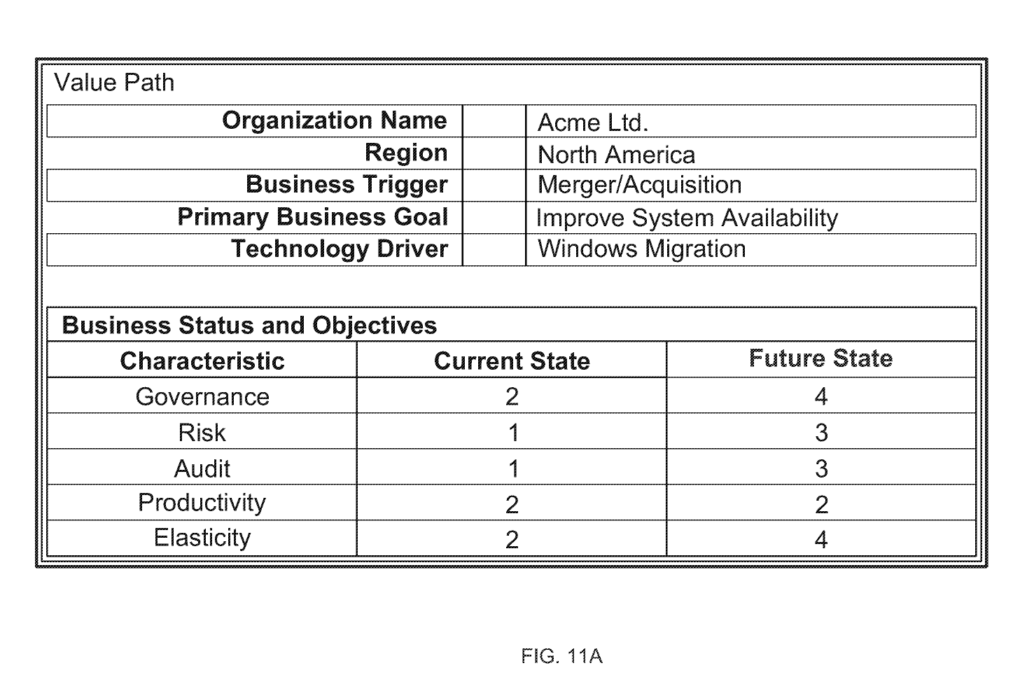

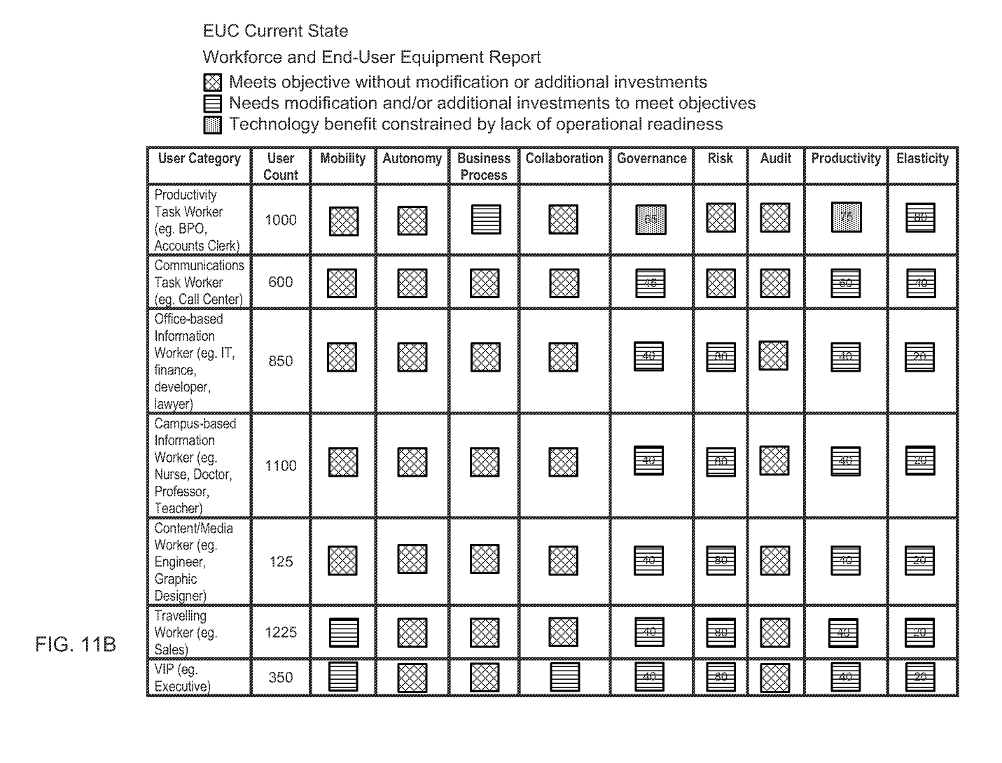

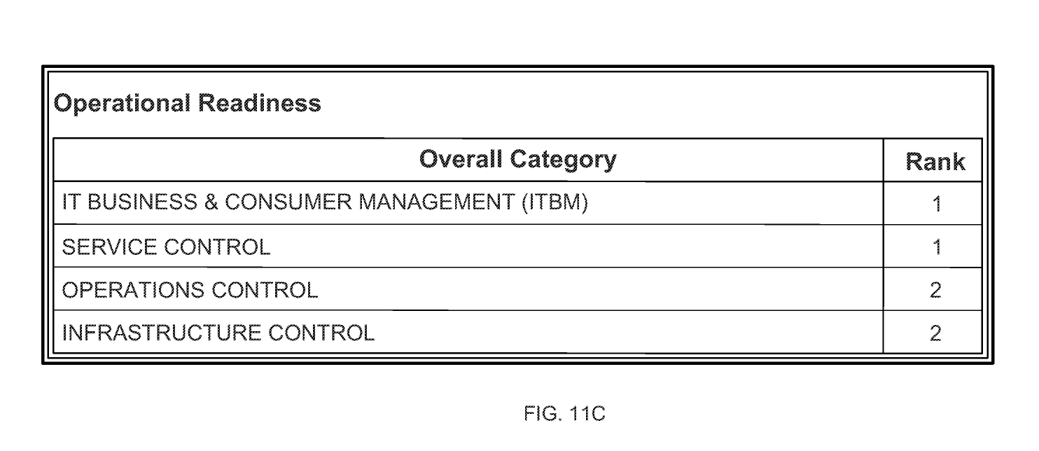

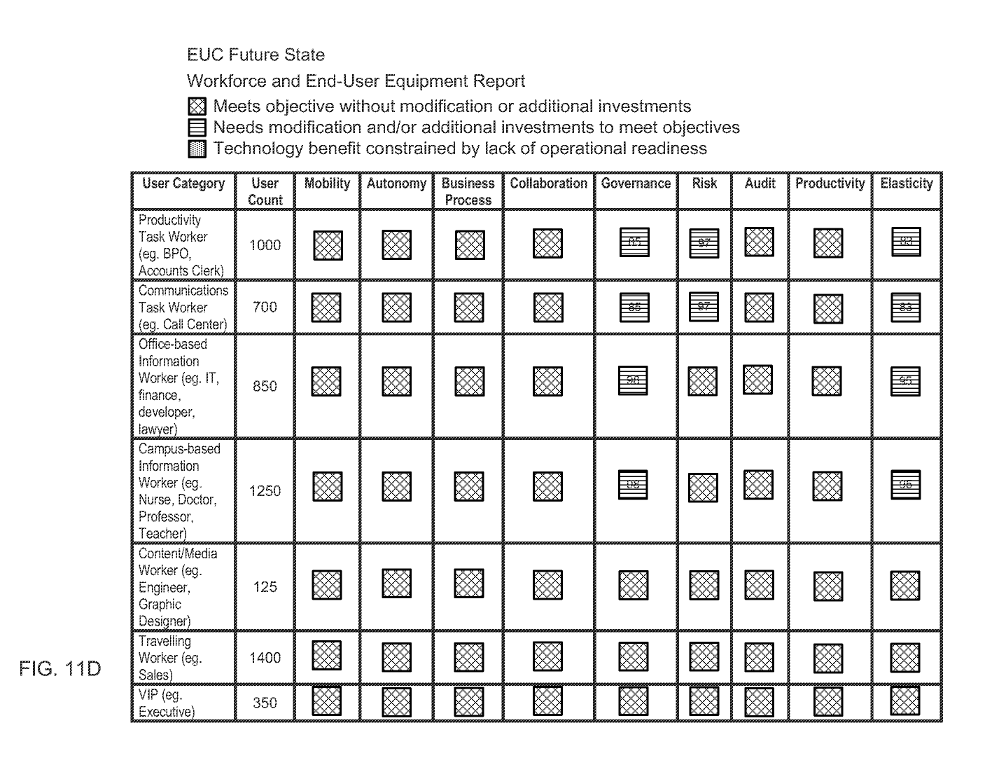

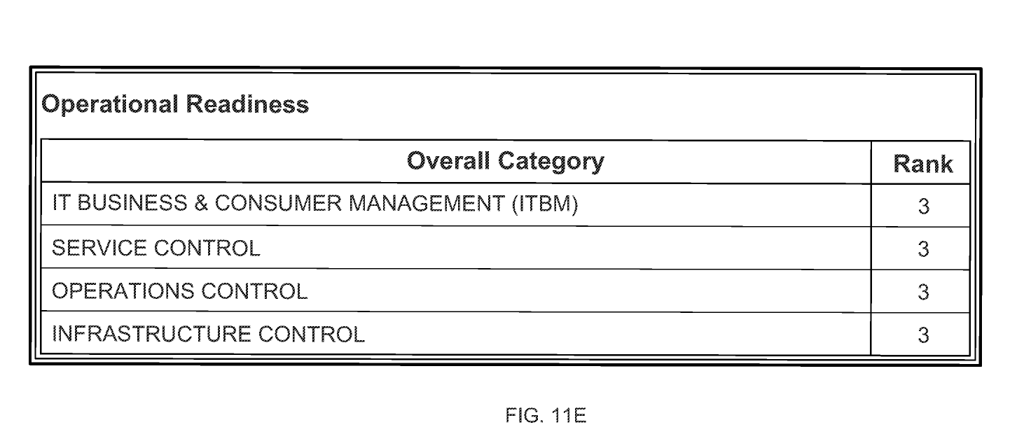

In some cases, in addition or in the alternative, a customer may receive a report for the EUC plan as shown in FIGS. 11A-E. Referring to FIG. 1, for example, a report generator module 132g can generate the report for output to the user on the display device 122. The report generator module 132g can also store the report in the database 104b.

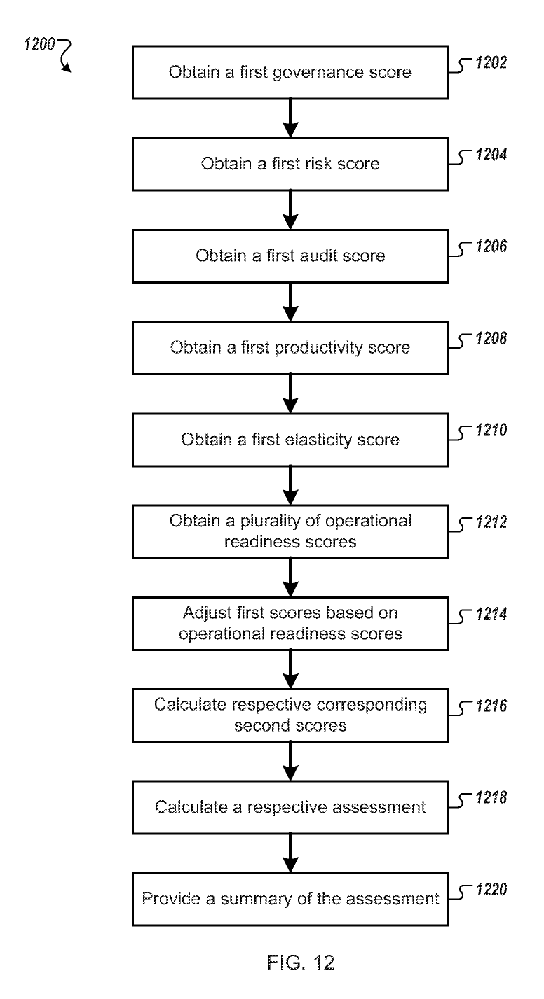

FIG. 12 is a flowchart of an example method 1200 that can execute implementations of the present disclosure. One or more computer programs installed on one or more computers can implement the method 1200. The method 1200 can be described as being performed by a system of one or more computers. In one example, the system 100 in FIG. 1 can perform the method 1200.

A first governance score is obtained (1202). Referring to FIGS. 1, 2B, 3, and 4, the assigned scores for the customer-selected answers for the questions associated with the governance parameter are summed to obtain the first governance score. The first governance score can be a measure of federation for a platform, where the platform comprises a device type attribute for a category of users. The governance score can be based on a score indicating which devices can be used by workers, a score indicating who decides which applications are deployed to workers, or a score indicating how end-user computing management and security processes are applied. For example, the GRAPE model generator module 132c can access the database 104b to obtain the assigned scores for the customer-selected answers for the questions associated with the governance parameter and can sum the scores in order to calculate the first governance score.

A first risk score is obtained (1204). Referring to FIGS. 2B, 3, and 4, the assigned scores for the customer-selected answers for the questions associated with the risk parameter are summed to obtain the first risk score. The first risk score can be a measure of risk tolerance for a platform. The risk score can be based on a score indicating how a deployment lifecycle of end-user assets is managed, a score indicating how end-user applications are kept up to date, or a score indicating an ability to withstand unplanned outages in end-user systems. For example, the GRAPE model generator module 132c can access the database 104b to obtain the assigned scores for the customer-selected answers for the questions associated with the risk parameter and can sum the scores in order to calculate the first risk score.

A first audit score is obtained (1206). Referring to FIGS. 2B, 3, and 4, the assigned scores for the customer-selected answers for the questions associated with the audit parameter are summed to obtain the first audit score. The first audit score can be a measure of record keeping ability for a platform. The first audit score can be based on a score indicating a degree to which records of user activity and access are maintained, a score indicating a degree to which the organization is obliged to comply with external regulations, or a score indicating a balance sheet approach to end-user assets. For example, the GRAPE model generator module 132c can access the database 104b to obtain the assigned scores for the customer-selected answers for the questions associated with the audit parameter and can sum the scores in order to calculate the first audit score.

A first productivity score is obtained (1208). Referring to FIGS. 2B, 3, and 4, the assigned scores for the customer-selected answers for the questions associated with the productivity parameter are summed to obtain the first productivity score. The first productivity score is a measure of workforce productivity for the platform. The first productivity score can be based on a score indicating user satisfaction with tools to perform work tasks, or a score indicating an assessment of the organization's workforce productivity in comparison to competitors or peers. For example, the GRAPE model generator module 132c can access the database 104b to obtain the assigned scores for the customer-selected answers for the questions associated with the productivity parameter and can sum the scores in order to calculate the first productivity score.

A first elasticity score is obtained (1210). Referring to FIGS. 2B, 3, and 4, the assigned scores for the customer-selected answers for the questions associated with the elasticity parameter are summed to obtain the first elasticity score. The first elasticity score can be a measure of change tolerance for the platform. The elasticity score can be based on a score indicating how often the organization expects to acquire or merge with other companies, a score indicating workforce growth or contraction plans, or a score indicating types of locations the organization's users work from. For example, the GRAPE model generator module 132c can access the database 104b to obtain the assigned scores for the customer-selected answers for the questions associated with the elasticity parameter and can sum the scores in order to calculate the first elasticity score.

A plurality of operational readiness scores are obtained (1212). Referring to FIGS. 9A-B, operational readiness scores are determined based on the assigned scores of the selected answers for the operational readiness parameters. The operational readiness scores can be measures of processes used to manage a platform within an organization. For example, the operational readiness module 132f can access the database 104b to obtain the plurality of operational readiness scores.

First scores are adjusted based on the operational readiness scores (1214). Referring to FIGS. 10A-D, the operational readiness scores may be applied to one or more of the GRAPE parameters when determining GRAPE modifiers.

Respective corresponding second scores are obtained (1216). Referring to FIGS. 10A-D, the GRAPE modifiers are applied to base GRAPE scores. The second score pertains to the organization.

A respective assessment is calculated (1218). Referring to FIGS. 10A-D, the first score is compared to the second score. The respective assessment is based on the comparison. For example, one or more of the software modules 132a-g included in the EUC planning application 130 can perform steps 1214 and 1216.

A summary of the assessment is provided (1220). Referring to FIG. 10D and FIGS. 11A-E the assessment summary can be a chart for display to the customer on a display device. In addition or in the alternative, the assessment summary can be a report. For example, referring to FIG. 1, the report generator module 132g can generate the report and the end-user equipment module 132d can generate the chart.

Though the examples described are for a particular user category and platform, similar processes and calculations can be performed for other user categories and platforms. In addition, though the examples and processes described are for an EUC current state, similar examples and processes can be performed for a desired future EUC state.

Embodiments of the subject matter and the operations described in this document can be implemented in digital electronic circuitry, or in computer software, firmware, or hardware, including the structures disclosed in this document and their structural equivalents, or in combinations of one or more of them. Embodiments of the subject matter described in this document can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this document can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this document can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this document can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this document, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
obtaining a first governance score wherein the first governance score is a measure of federation for a platform, wherein the platform comprises a device type attribute for a category of users;
obtaining a first risk score wherein the first risk score is a measure of risk tolerance for the platform;
obtaining a first audit score wherein the first audit score is a measure of record keeping ability for the platform;
obtaining a first productivity score wherein the first productivity score is a measure of workforce productivity for the platform;
obtaining a first elasticity score wherein the first elasticity score is a measure of change tolerance for the platform;
obtaining a plurality of operational readiness scores, wherein the operational readiness scores are measures of processes used to manage the platform within an organization;
adjusting the first scores based on the operational readiness scores;
calculating, for each of the first scores, a respective corresponding second score pertaining to the organization;
calculating a respective assessment for each of the adjusted first scores based on a comparison of the adjusted first score with the corresponding second score; and
providing a summary of the assessments.

2. The method of claim 1 wherein the platform further comprises one or more of the following attributes: access and mobility information, personalization information, unified communications and collaboration information, application management and delivery information, data access information, desktop and workspace information, security and compliance information, and management information.

3. The method of claim 2 wherein each first governance score is based on respective governance scores obtained for one or more of the platform attributes, each first risk score is based on respective risk scores obtained for one or more of the platform attributes, each first audit score is based on respective audit scores obtained for one or more of the platform attributes, each first productivity score is based on respective productivity scores obtained for one or more of the platform attributes, and each first elasticity score is based on respective elasticity scores obtained for one or more of the platform attributes.

4. The method of claim 1 wherein the user category is productivity task worker, communications task worker, office-based information worker, campus-based information worker, traveling worker or a very important person.

5. The method of claim 1 wherein calculating the respective assessment for each of the adjusted first scores based on a comparison of the adjusted first score with the corresponding second score comprises:
determining whether the adjusted first score is less than, greater than, or equal to the second score; and
calculating the respective assessment based on the determination.

6. The method of claim 1 wherein the summary is a color-coded depiction of the assessments.

7. The method of claim 1 wherein obtaining the plurality of operational readiness scores comprises:
obtaining a first operational readiness score wherein the first operational readiness score is a measure of information technology strategy and management of the organization;
obtaining a second operational readiness score wherein the second operational readiness score is a measure of processes that enable information technology to be provided as a service in the organization;
obtaining a third operational readiness score wherein the third operational readiness score is a measure of business as usual operating processes for managing information technology in the organization; and
obtaining a fourth operational readiness score wherein the fourth operational readiness score is a measure of design and creation of new or updated services in the organization.

8. The method of claim 7 wherein adjusting a particular one of the first scores based on the operational readiness scores comprises:
adjusting the particular first score based on one or more of the operational readiness scores.

9. The method of claim 1 wherein adjusting a particular one of the first scores based on the operational readiness scores comprises reducing the particular first score.

10. A system comprising:
data processing apparatus programmed to perform operations comprising:
obtaining a first governance score wherein the first governance score is a measure of federation for a platform, wherein the platform comprises a device type attribute for a category of users;
obtaining a first risk score wherein the first risk score is a measure of risk tolerance for the platform;
obtaining a first audit score wherein the first audit score is a measure of record keeping ability for the platform;
obtaining a first productivity score wherein the first productivity score is a measure of workforce productivity for the platform;
obtaining a first elasticity score wherein the first elasticity score is a measure of change tolerance for the platform;
obtaining a plurality of operational readiness scores, wherein the operational readiness scores are measures of processes used to manage the platform within an organization;
adjusting the first scores based on the operational readiness scores;
calculating, for each of the first scores, a respective corresponding second score pertaining to the organization;
calculating a respective assessment for each of the adjusted first scores based on a comparison of the adjusted first score with the corresponding second score; and
providing a summary of the assessments.

11. The system of claim 10 wherein the platform further comprises one or more of the following attributes: access and mobility information, personalization information, unified communications and collaboration information, application management and delivery information, data access information, desktop and workspace information, security and compliance information, and management information.

12. The system of claim 11 wherein each first governance score is based on respective governance scores obtained for one or more of the platform attributes, each first risk score is based on respective risk scores obtained for one or more of the platform attributes, each first audit score is based on respective audit scores obtained for one or more of the platform attributes, each first productivity score is based on respective productivity scores obtained for one or more of the platform attributes, and each first elasticity score is based on respective elasticity scores obtained for one or more of the platform attributes.

13. The system of claim 10 wherein the user category is productivity task worker, communications task worker, office-based information worker, campus-based information worker, traveling worker or a very important person.

14. The system of claim 10 wherein the operations of calculating the respective assessment for each of the adjusted first scores based on a comparison of the adjusted first score with the corresponding second score comprises:
determining whether the adjusted first score is less than, greater than, or equal to the second score; and
calculating the respective assessment based on the determination.

15. The system of claim 10 wherein the summary is a color-coded depiction of the assessments.

16. The system of claim 10 wherein the operations of obtaining the plurality of operational readiness scores comprises:
obtaining a first operational readiness score wherein the first operational readiness score is a measure of information technology strategy and management of the organization;
obtaining a second operational readiness score wherein the second operational readiness score is a measure of processes that enable information technology to be provided as a service in the organization;
obtaining a third operational readiness score wherein the third operational readiness score is a measure of business as usual operating processes for managing information technology in the organization; and
obtaining a fourth operational readiness score wherein the fourth operational readiness score is a measure of design and creation of new or updated services in the organization.

17. The system of claim 16 wherein the operation of adjusting a particular one of the first scores based on the operational readiness scores comprises:
adjusting the particular first score based on one or more of the operational readiness scores.

18. The system of claim 10 wherein the operation of adjusting a particular one of the first scores based on the operational readiness scores comprises reducing the particular first score.

19. A non-transitory machine readable storage medium embodying computer software, the computer software causing a computer to perform a method, the method comprising:
obtaining a first governance score wherein the first governance score is a measure of federation for a platform, wherein the platform comprises a device type attribute for a category of users;
obtaining a first risk score wherein the first risk score is a measure of risk tolerance for the platform;
obtaining a first audit score wherein the first audit score is a measure of record keeping ability for the platform;
obtaining a first productivity score wherein the first productivity score is a measure of workforce productivity for the platform;
obtaining a first elasticity score wherein the first elasticity score is a measure of change tolerance for the platform;
obtaining a plurality of operational readiness scores, wherein the operational readiness scores are measures of processes used to manage the platform within an organization;
adjusting the first scores based on the operational readiness scores;
calculating, for each of the first scores, a respective corresponding second score pertaining to the organization;
calculating a respective assessment for each of the adjusted first scores based on a comparison of the adjusted first score with the corresponding second score; and
providing a summary of the assessments.

20. The storage medium of claim 19 wherein the platform further comprises one or more of the following attributes: access and mobility information, personalization information, unified communications and collaboration information, application management and delivery information, data access information, desktop and workspace information, security and compliance information, and management information.

21. The storage medium of claim 20 wherein each first governance score is based on respective governance scores obtained for one or more of the platform attributes, each first risk score is based on respective risk scores obtained for one or more of the platform attributes, each first audit score is based on respective audit scores obtained for one or more of the platform attributes, each first productivity score is based on respective productivity scores obtained for one or more of the platform attributes, and each first elasticity score is based on respective elasticity scores obtained for one or more of the platform attributes.

22. The storage medium of claim 19 wherein the user category is productivity task worker, communications task worker, office-based information worker, campus-based information worker, traveling worker or a very important person.

23. The storage medium of claim 19 wherein calculating the respective assessment for each of the adjusted first scores based on a comparison of the adjusted first score with the corresponding second score comprises:
determining whether the adjusted first score is less than, greater than, or equal to the second score; and
calculating the respective assessment based on the determination.

24. The storage medium of claim 19 wherein the summary is a color-coded depiction of the assessments.

25. The storage medium of claim 19 wherein obtaining the plurality of operational readiness scores comprises:
obtaining a first operational readiness score wherein the first operational readiness score is a measure of information technology strategy and management of the organization;
obtaining a second operational readiness score wherein the second operational readiness score is a measure of processes that enable information technology to be provided as a service in the organization;
obtaining a third operational readiness score wherein the third operational readiness score is a measure of business as usual operating processes for managing information technology in the organization; and
obtaining a fourth operational readiness score wherein the fourth operational readiness score is a measure of design and creation of new or updated services in the organization.

26. The storage medium of claim 25 wherein adjusting a particular one of the first scores based on the operational readiness scores comprises:
adjusting the particular first score based on one or more of the operational readiness scores.

27. The storage medium of claim 19 wherein adjusting a particular one of the first scores based on the operational readiness scores comprises reducing the particular first score.
